(19) United States
(12) Patent Application Publication
(10) Pub. No.: US 2011/0248909 A1
(43) Pub. Date: Oct. 13, 2011

(54) ELECTROPHORETIC DISPLAY DEVICE AND ELECTRONIC APPARATUS

(75) Inventor: Takashi SATO, Chino (JP)

(73) Assignee: SEIKO EPSON CORPORATION, Tokyo (JP)

(21) Appl. No.: 13/083,934

(22) Filed: Apr. 11, 2011

(30) Foreign Application Priority Data
Apr. 12, 2010 (JP) 2010-091370
Mar. 15, 2011 (JP) 2011-056717

(51) Int. Cl. G09G 3/34

(52) U.S. Cl. 345/107

(57) ABSTRACT

Provided is an electrophoretic display device including: a first substrate; a second substrate; an electrophoretic layer which is arranged between the first substrate and the second substrate and has at least a dispersion medium and particles mixed in the dispersion medium; a plurality of first electrodes which is formed in an island shape on the electrophoretic layer side of the first substrate and is provided for each pixel; and a second electrode which is formed on the electrophoretic layer side of the second substrate with an area wider than that of the first pixel electrode. Gradation is controlled using an area of the particles which are visually recognized when the electrophoretic layer is viewed from the second electrode side.

### CROSS-REFERENCE TO RELATED APPLICATION

This application is based on and claims priority from Japanese Patent Application No. 2010-091370, filed on Apr. 12, 2010, and Japanese Patent Application No. 2011-056717, filed on Mar. 15, 2011, the contents of which are incorporated herein by reference.

### BACKGROUND

1. Technical Field

The present invention relates to an electrophoretic display device and an electronic apparatus.

2. Related Art

In recent years, electrophoretic display devices have come to be used as a display portion such as electronic paper. An electrophoretic display device has a configuration which has an electrophoretic dispersion liquid where a plurality of electrophoretic particles is dispersed in a liquid-phase dispersion medium (dispersion medium). The electrophoretic display device is a device used for display where the distribution state of the electrophoretic particles changes due to the application of an electric field and the optical properties of the electrophoretic dispersion liquid changes.

In regard to the electrophoretic display device such as this, the concept of a color electrophoretic display device is proposed which uses three particles such as is disclosed in JP-A-2009-9092 and JP-A-2009-98382. Here, three particles are disclosed, a particle which is charged with a positive charge, a particle which is charged with a negative charge, and a particle with no charge which are driven using three electrodes.

In JP-A-2009-9092 and JP-A-2009-98382 described above, there is disclosed a concept of controlling the two charged particles using two pixel electrodes in one sub pixel, but the relationship of the specific form of the pixel electrode and the form of the transistor is not shown. There are issues with the controllability of brightness and saturation in one sub pixel in order to realize a color electrophoretic display device, and it is difficult to perform a full-color display. Therefore, in the color electrophoretic display device, a method is desirable where at least one or all three of brightness, saturation, and hue are controlled in an analog manner.

In addition, when pixel electrodes are arranged in a regular layout and an electrophoretic display device is manufactured with a matrix shape, streaks are displayed in accordance with the regular arrangement of the pixel electrodes. A pixel layout and form which resolves this is also an issue.

### SUMMARY

An advantage of some aspects of the invention is that an electrophoretic display device and an electronic apparatus are provided which are able to control at least one or all three of brightness, saturation, and hue by controlling movement of electrophoretic particles and to perform an excellent color display.

An electrophoretic display device according to an aspect of the invention is provided with a first substrate, a second substrate, an electrophoretic layer which is arranged between the first substrate and the second substrate and has at least a dispersion medium and particles mixed in the dispersion medium, a plurality of first electrodes which is formed in an island shape on the electrophoretic layer side of the first substrate and is provided for each pixel, a second electrode which is formed on the electrophoretic layer side of the second substrate with an area wider than that of the first pixel electrode, where gradation is controlled using an area of the particles which are visually recognized when the electrophoretic layer is viewed from the second electrode side.

According to the aspect, the plurality of first electrodes is provided for each pixel, and using a polarity, size or the like of a voltage applied to the plurality of first electrodes, it is possible to control the movement and the distribution range on the second electrode side of the particles mixed in the dispersion medium of the electrophoretic layer. In addition, it is possible to provide an electrophoretic display device which is a display portion which corresponds from a one-particle system to a three-particle system and performs an excellent color display. According to the aspect, since it is possible to distribute the particles on the second electrode by applying an arbitrary voltage to the first electrode and the second electrode, a desired color display can be obtained by controlling the gradation using an area of the particles which are visually recognized when the electrophoretic layer is viewed from the second electrode side.

In addition, it is preferable that the plurality of first electrodes is mutually connected by a connection electrode formed in a layer further to the first substrate side than the first electrodes.

According to the aspect, it is possible to apply the same voltage simultaneously to the plurality of first electrodes and it becomes easy to control voltage application.

In addition, it is preferable that the electrophoretic display device has a scanning line and a data line, a transistor which is connected to the scanning line and the data line is arranged in the pixel, and the connection electrode is formed in a different layer to a drain electrode of the transistor.

According to the aspect, since the connection electrode is formed in a different layer to the drain electrode of the transistor, it is possible for the first electrode to also be arranged on the transistor. According to this, it is possible to improve the degree of design freedom with regard to the arrangement of the electrodes and to provide many electrodes.

In addition, it is preferable that the connection electrode overlaps with at least a portion of the transistor in a planar view.

According to the aspect, it is possible for the first connection electrode to also be arranged on the transistor. According to this, it is possible to improve the degree of design freedom with regard to the arrangement of the first electrode and to provide many electrodes.

In addition, it is preferable that the total area of the plurality of first electrodes in the pixel is equal to or less than ¼ of the area of the pixel.

According to the aspect, since the total area of the plurality of first electrodes in the pixel is equal to or less than ¼ of the area of the pixel, it is possible to distribute the particles in small dot regions on the second electrode, and as a result, the gradation width is broadened.

In addition, it is preferable that the width of the first electrodes in a direction where the first electrodes are adjacent to each other is shorter than a gap between the first electrode and the second electrode.

According to the aspect, it is possible to perform small dot display. It is possible to adjust the gradation (color) using the size of the dots.

In addition, it is preferable that the plurality of first electrodes provided in the pixel includes two or more types of electrodes which have sizes different from each other.

According to the aspect, it is possible to resolve the streaks and interference bands generated when displaying and an excellent color display can be obtained.

An electrophoretic display device according to ano aspect of the invention is provided with a first substrate, a second substrate, an electrophoretic layer which is arranged between the first substrate and the second substrate and has at least a dispersion medium and particles mixed in the dispersion medium, a plurality of first electrodes and a plurality of third electrodes which are formed in an island shape on the electrophoretic layer side of the first substrate and are provided in each pixel, a second electrode which is formed on the electrophoretic layer side of the second substrate with an area wider than the first electrode and the third electrode, where the first electrode and the third electrode are driven independently of each other and gradation is controlled using an area of the particles which are visually recognized when the electrophoretic layer is viewed from the second electrode side.

According to the aspect, the plurality of first electrodes and the plurality of third electrodes are provided for each pixel, and using a polarity, size or the like of a voltage applied to the plurality of first electrodes and the plurality of third electrodes, it is possible to control the movement and the distribution range on the second electrode side of the particles mixed in the dispersion medium of the electrophoretic layer. In addition, it is possible to provide an electrophoretic display device which is a display portion which corresponds from a one-particle system to a three-particle system and performs an excellent color display. According to the aspect, since it is possible to distribute the particles on the second electrode by applying an arbitrary voltage to the first electrode, the second electrode, and the third electrode, a desired color display can be obtained by controlling the gradation using an area of the particles which are visually recognized when the electrophoretic layer is viewed from the second electrode side.

In addition, it is preferable that the plurality of first electrodes is mutually connected by a first connection electrode formed in a layer further to the first substrate side than the first electrode and the plurality of third electrodes is mutually connected by a second connection electrode formed in a layer further to the first substrate side than the third electrode.

According to the aspect, it is possible to apply the same voltage simultaneously to the same type of electrodes (the plurality of first electrodes and the plurality of third electrodes) and it becomes easy to control voltage application.

In addition, it is preferable that there is a first scanning line, a second scanning line, a first data line, and a second data line, a first transistor which is connected to the first scanning line and the first data line and a second transistor which is connected to the second scanning line and the second data line are arranged in the pixel, and the first connection electrode is formed in a different layer to a drain electrode of the first transistor and the second connection electrode is formed in a different layer to a drain electrode of the second transistor.

According to the aspect, since the first and the second connection electrodes are formed in different layers to the drain electrode of the first and the second transistors, it is possible for the first or the third electrode to also be arranged on the first and the second transistors. According to this, it is possible to improve the degree of design freedom with regard to the arrangement of the first electrode and the third electrode which are connected to the first and the second connection electrodes and to provide many electrodes.

In addition, it is preferable that the first connection electrode overlaps with at least a portion of the first transistor in a planar view and the second connection electrode overlaps with at least a portion of the second transistor in a planar view.

According to the aspect, since it is possible for the first connection electrode to also be arranged on the first transistor and second connection electrode to also be arranged on the second transistor, it is possible to improve the degree of design freedom with regard to the arrangement of the first electrode and the third electrode which are connected to the first connection electrode and the second connection electrode and to provide many electrodes.

In addition, it is preferable that the total area of the plurality of first electrodes and the plurality of third electrodes in one pixel is equal to or less than ¼ of the area of one pixel.

According to the aspect, since the total area of the plurality of first electrodes and the plurality of third electrodes in one pixel is equal to or less than ¼ of the area of one pixel, it is possible to distribute the particles in small dot regions on the second electrode, and as a result, the gradation width is broadened.

In addition, it is preferable that the widths of the first electrode and the third electrode in a direction where the first electrode and the third electrode are adjacent to each other are shorter than a gap between the first electrode and the second electrode.

According to the aspect, it is possible to perform small dot display. It is possible to adjust the gradation (color) using the size of the dots.

In addition, it is preferable that the plurality of first electrodes provided in the pixel includes two or more types of electrodes which have sizes different from each other and the plurality of third electrodes provided in the pixel includes two or more types of electrodes which have sizes different from each other.

According to the aspect, it is possible to resolve the streaks and interference bands generated when displaying and an excellent color display can be obtained.

In addition, it is preferable that the plurality of first electrodes is arranged at equal intervals.

According to the aspect, the layout of the first electrode becomes easy due to the plurality of first electrodes being arranged at equal intervals.

In addition, it is preferable that the plurality of first electrodes is arranged at random positions.

According to the aspect, it is possible to resolve the streaks and interference bands generated when displaying and an excellent color display can be obtained.

In addition, it is preferable that the size of the plurality of first electrodes is random.

According to the aspect, it is possible to resolve the streaks and interference bands generated when displaying and an excellent color display can be obtained.

In addition, it is preferable that there is a first pixel and a second pixel, and the layout of the plurality of first electrodes in the first pixel is different from the layout of the plurality of first electrodes in the second pixel.

According to the aspect, it is possible to resolve the streaks and interference bands generated when displaying and an excellent color display can be obtained.

In addition, it is preferable that the first pixel and the second pixel are alternately arranged along the arrangement direction of the pixels.

According to the aspect, it is possible to resolve the streaks and interference bands generated when displaying and an excellent display can be obtained.

In addition, it is preferable that the layout of the first electrode includes two regions which are different from each other.

According to the aspect, it is possible to further prevent the generation of display streaks and interference bands, and manufacturing is easy since the pattern for each pixel is the same.

An electronic apparatus according to still another aspect of the invention is provided with the electrophoretic display device of the invention.

According to the aspect, there is a display device which corresponds to an excellent color display due to a configuration where a plurality of electrodes is provided in one pixel.

### BRIEF DESCRIPTION OF THE DRAWINGS

The invention will be described with reference to the accompanying drawings, wherein like numbers reference like elements.

FIG. 1A is a planar diagram illustrating an overall configuration of an electrophoretic display device according to a first embodiment and FIG. 1B is an equivalent circuit diagram illustrating an overall configuration of the electrophoretic display device.

FIG. 2 is a partial cross-sectional diagram of one pixel of the electrophoretic display device.

FIGS. 3A to 3D are diagrams for describing an operating principle of the electrophoretic display device which uses three particles.

FIG. 4 is a diagram for describing an operating principle of the electrophoretic display device which uses three particles.

FIG. 5 is an explanatory diagram illustrating a distribution of pixel electrodes in one pixel.

FIG. 6 is a diagram illustrating a distribution state of cyan particles when displaying cyan.

FIG. 7 is a diagram illustrating a distribution state of cyan particles, yellow particles, and magenta particles when displaying black.

FIG. 8 is a diagram illustrating a distribution state of cyan particles, yellow particles, and magenta particles when displaying white.

FIG. 9 is an equivalent circuit diagram of the electrophoretic display device.

FIG. 10 is a planar diagram illustrating a schematic configuration of one pixel.

FIG. 11 is a planar diagram illustrating a specific configuration example of one pixel.

FIG. 12 is a cross-sectional diagram along a line XII-XII of FIG. 11.

FIG. 13 is a cross-sectional diagram illustrating a schematic configuration of one pixel of the electrophoretic display device.

FIGS. 14A to 14C are partial cross-sectional diagrams for describing a manufacturing process of the electrophoretic display device according to the first embodiment.

FIGS. 15A to 15C are partial cross-sectional diagrams for describing a manufacturing process of the electrophoretic display device according to the first embodiment.

FIG. 16 is a partial cross-sectional diagram for describing a manufacturing process of the electrophoretic display device according to the first embodiment.

FIG. 17 is a planar diagram illustrating a schematic configuration of one pixel according to a second embodiment.

FIG. 18 is a cross-sectional diagram along a line XVIII-XVIII of FIG. 17.

FIGS. 19A to 19D are partial cross-sectional diagrams for describing a manufacturing process of an electrophoretic display device according to the second embodiment.

FIGS. 20A to 20C are partial cross-sectional diagrams for describing a manufacturing process of the electrophoretic display device according to the second embodiment.

FIGS. 21A and 21B are partial cross-sectional diagrams for describing a manufacturing process of the electrophoretic display device according to the second embodiment.

FIG. 22A is a planar diagram schematically illustrating a state of a pixel arrangement in a display region of an electrophoretic display device according to a third embodiment and FIG. 22B is a planar diagram illustrating a configuration of one pixel.

FIG. 23 is a planar diagram illustrating a specific configuration example of one pixel.

FIG. 24 is a planar diagram illustrating a simplification of a pixel configuration of a modified example 1.

FIG. 25 is a planar diagram illustrating a pixel configuration shown in FIG. 24 in detail.

FIG. 26 is a planar diagram illustrating a pixel configuration of a modified example 2.

FIG. 27 is a planar diagram illustrating a layout of a pixel electrode in one pixel of a modified example 3.

FIG. 28 is a planar diagram illustrating a simplification of a configuration in one pixel.

FIG. 29 is a planar diagram illustrating a configuration of one pixel in detail.

FIG. 30 is a planar diagram illustrating a different layout of a pixel electrode.

FIG. 31 is a planar diagram illustrating another configuration example of a pixel electrode.

FIG. 32 is a planar diagram illustrating a configuration of one pixel shown in FIG. 31 in detail.

FIGS. 33A to 33D are cross-sectional diagrams illustrating schematic configurations of other applied examples.

FIGS. 34A and 34B are cross-sectional diagrams illustrating schematic configurations of other applied examples.

FIG. 35 is an equivalent circuit diagram of a one-particle system.

FIG. 36 is a planar diagram illustrating a layout of a pixel electrode.

FIG. 37 is a planar diagram illustrating a schematic configuration of one pixel (regular intervals).

FIG. 38 is a planar diagram illustrating another configuration of one pixel (random).

FIGS. 39A to 39C are diagrams illustrating a modified example of a pixel electrode.

FIGS. 40A to 40C are diagrams illustrating examples of electronic apparatuses.

FIG. 41 is a diagram illustrating the distribution state of charged particles when a voltage is applied.

FIGS. 42A and 42B are diagrams illustrating the distribution state of charged particles when a voltage is applied.

FIG. 43 is a planar diagram illustrating a modified example of a layout of one pixel (modified example of the configuration shown in FIGS. 10 and 11).

FIG. 44 is a cross-sectional diagram along a line XLIV of FIG. 43.

FIGS. 45A to 45D are diagrams illustrating the distribution state of the charged particles in a configuration example of another electrophoretic display device.

FIGS. 46A to 46B are diagrams illustrating the distribution state of the charged particles in a configuration example of another electrophoretic display device.

### DESCRIPTION OF EXEMPLARY EMBODIMENTS

Below, the embodiments of the invention will be described with reference to the diagrams. In addition, in each diagram used in the description below, scaling of each component is suitably changed in order to make each component an identifiable size. In the specifications, each of the colors red, green, and blue will be respectively denoted by R, G and B, and each of the colors cyan, magenta, and yellow will be respectively denoted by C, M, and Y.

### First Embodiment

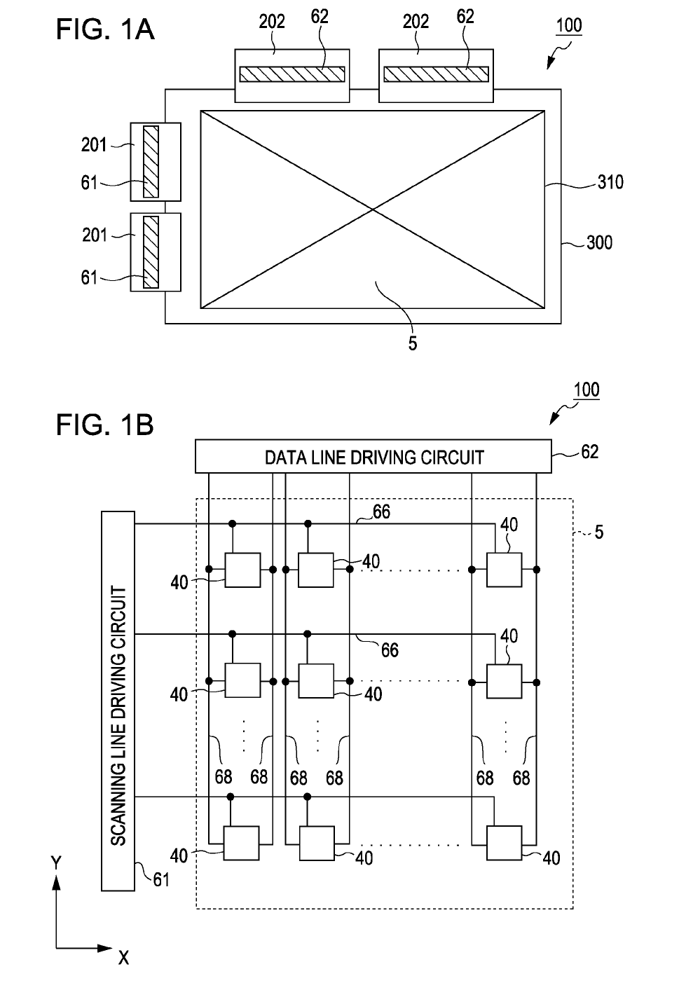

FIG. 1A is a planar diagram illustrating an overall configuration of an electrophoretic display device 100.

As shown in FIG. 1A, in the electrophoretic display device 100 of the embodiment, an element substrate 300 has larger planar dimensions than that of an opposing substrate 310, and on the element substrate 300 which protrudes to the outside more than the opposing substrate 310, two scanning line driving circuits 61 and two data line driving circuits 62 are COF (Chip On Film) mounted (or TAB (Tape Automated Bonding) mounted) on flexible substrates 201 and 202 which are for connection to external devices. Then, the flexible substrates 201, where the scanning line driving circuits 61 are mounted, are mounted in terminal formation regions formed on a side edge portion along one short side of the element substrate 300 via ACP (anisotropic conductive paste), ACF (anisotropic conductive film), or the like. Here, the element substrate 300 is configured of the first substrate 30 described later as a base substrate and the opposing substrate 310 is configured of the second substrate 31 described later as a base substrate.

In addition, the flexible substrates 202, where the data line driving circuits 62 are mounted, are mounted in terminal formation regions formed on a side edge portion along one long side of the element substrate 300 via ACP, ACF, or the like. In each of the terminal formation regions, a plurality of connection terminals is formed, and scanning lines and data lines described later which extend from a display portion 5 are connected to each of the connection terminals.

In addition, the display portion 5 is formed in a region where the element substrate 300 and the opposing substrate 310 overlap, and the lines which extend from the display portion 5 (scanning lines 66 and data lines 68) extend to the region where the scanning line driving circuits 61 and the data line driving circuits 62 are mounted and are connected to the connection terminals formed in the mounting region. Then, the flexible substrates 201 and 202 are mounted with regard to the connection terminals via ACP or ACF.

FIG. 1B is an equivalent circuit diagram illustrating an overall configuration of the electrophoretic display device.

As shown in FIG. 1B, in the display portion 5 in the electrophoretic display device 100, a plurality of pixels 40 is arranged in a matrix formation. In the periphery of the display portion 5, the scanning line driving circuits 61 and the data line driving circuits 62 are arranged. The scanning line driving circuits 61 and the data line driving circuits 62 are each connected to a controller (not shown). The controller comprehensively controls the scanning line driving circuits 61 and the data line driving circuits 62 based on image data and synchronization signals supplied from a high-level device.

In the display portion 5, a plurality of the scanning lines 66 which extend from the scanning line driving circuit 61 and a plurality of the data lines 68 which extend from the data line driving circuit 62 are formed, and the pixels 40 are provided to correspond to intersection positions of the scanning lines 66 and the data lines 68. In each of the pixels 40, two different data lines 68 are connected.

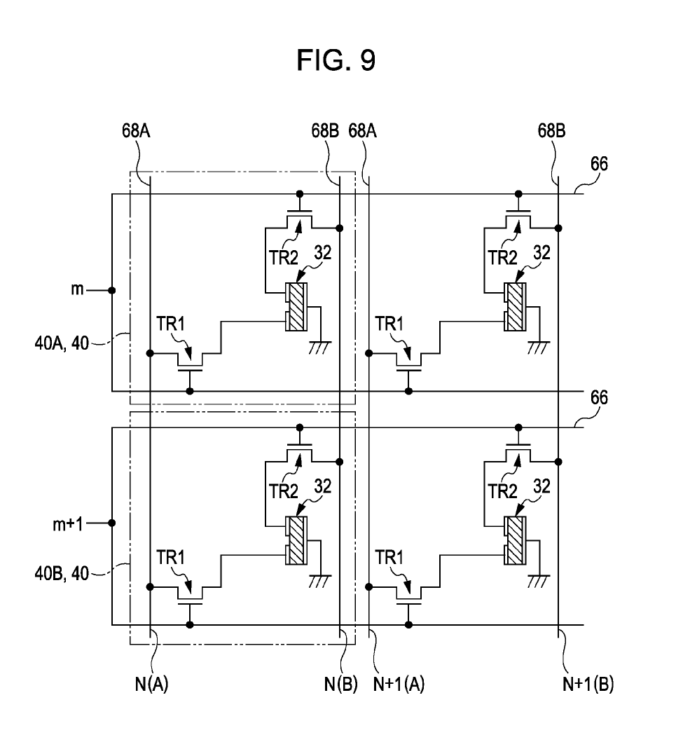

The scanning line driving circuit 61 is connected to each of the pixels 40 via the plurality of scanning lines 66, each of the scanning lines 66 is sequentially selected at the control of the controller, and selection signals, which regulate the on timing of selection transistors TR1 and TR2 (refer to FIG. 9) provided in the pixel 40, are supplied via the selected scanning line 66. The data line driving circuit 62 is connected to each of the pixels 40 via the plurality of data lines 68, and image signals, which regulate pixel data corresponding to each of the pixels 40, are supplied to the pixels 40 at the control of the controller.

Next, a color display method of the electrophoretic display device will be described.

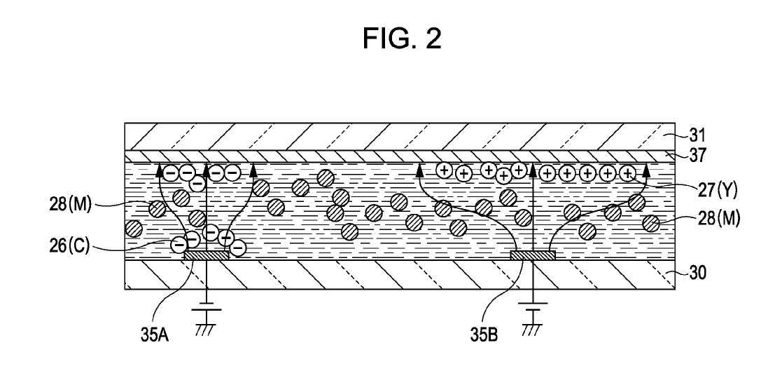

FIG. 2 is a partial cross-sectional diagram of one pixel of the electrophoretic display device. In addition, in FIG. 5, each configuration is simplified in order to describe a principle.

As shown in FIG. 2, in the electrophoretic display device, an electrophoretic layer 32 is interposed between the first substrate 30 and the second substrate 31. The electrophoretic layer 32 holds (disperses) negatively charged particles 26 (C) with a cyan color which have a negative charge (second electrophoretic particles), positively charged particles 27 (Y) with a yellow color which have a positive charge (first electrophoretic particles), and non-charged particles 28 (M) with a magenta color (third electrophoretic particles) in a transparent dispersion medium 21 (T). The charged particles (the negatively charged particles 26 (C) and the positively charged particles 27 (Y)) act as electrophoretic particles in the electrophoretic layer 32.

In the electrophoretic layer 32 side of the first substrate 30, a first pixel electrode 35A (first electrode) and a second pixel electrode 35B (third electrode) which are driven independently from each other are formed, and in the electrophoretic layer 32 side of the second substrate 31, an opposing electrode 37 (second electrode) is formed with an area wider than those of the first pixel electrode 35A and the second pixel electrode 35B. The opposing electrode 37 is formed in a region which covers the first pixel electrode 35A and the second pixel electrode 35B in a planar view and covers at least a portion of the second substrate 31 which contributes to the display. The electrophoretic display device 100 is viewed from the second substrate 31 side.

The negatively charged particles 26 (C) and the positively charged particles 27 (Y) are controlled using an electric field which is generated between the first pixel electrode 35A and the opposing electrode 37 and an electric field which is generated between the second pixel electrode 35B and the opposing electrode 37. In FIG. 2, the opposing electrode 37 is set to a ground potential. In addition, out of the positive voltages applied to the first pixel electrode 35A and the second pixel electrode 35B, the voltage which is an absolute maximum is a voltage VH (referred to below as maximum positive value), and out of the negative voltages applied to the first pixel electrode 35A and the second pixel electrode 35B, the voltage which is an absolute maximum is a voltage VL (referred to below as maximum negative value). Furthermore, a voltage Vh is a positive voltage with a smaller absolute value than the voltage VH and a voltage V1 is a negative voltage with a smaller absolute value than the voltage VL. In addition, “applying a voltage to a pixel electrode” has the same meaning as “supplying a potential which generates the voltage between it and a ground potential to an electrode”.

FIG. 2 shows how the negatively charged particles 26 (C) and the positively charged particles 27 (Y) are distributed on the opposing electrode 37 (second electrode) on the second substrate 31 side. On a left side of FIG. 2, a negative voltage V1 with a size of an intermediate degree which has a smaller absolute value than the voltage VL is applied in the first pixel electrode 35A. An electric field is generated, which is caused by a difference in potential between a potential corresponding to the potential V1 of the first pixel electrode 35A and the ground potential of the opposing electrode 37, between the first pixel electrode 35A and the opposing electrode 37, and the negatively charged particles 26 (C) which have a negative charge move to the opposing electrode 37 side due to the electric field. Here, since the voltage between the electrodes is not large, the negatively charged particles 26 (C) are distributed so as to hardly spread out on the opposing electrode 37. This is due to the following reason.

That is, the negatively charged particles 26 (C) move even due to an inclined electric field (an electric field from the first pixel electrode 35A which has a line of electric force with an inclined direction with regard to a normal line of the first substrate 30), but the inclined electric field does not become large since the original electric field is not large. As such, the amount of movement of the negatively charged particles 26 (C) is small in a direction which is parallel to the second substrate 31, and it is possible for the negatively charged particles 26 (C) to be concentrated in a narrow range and realize a distribution in a spot manner. In addition, the number of moved particles is also small. As such, here, a small area of cyan display is performed.

In addition, when the voltage VL (maximum negative voltage) is applied to the first pixel electrode 35A, since the voltage between the electrodes becomes larger than the state of the left side of FIG. 2, the electric field generated between the electrodes becomes large, and more of the negatively charged particles 26 (C) than in the state of the left side of FIG. 2 move to the second substrate 31 side. Typically, all of the negatively charged particles 26 (C) move to the second substrate 31 side. In addition, since the original electric field becomes large, according to this, the inclined electric field also becomes large, and the amount of movement of the negatively charged particles 26 (C) is large in the direction which is parallel to the second substrate 31, and the negatively charged particles 26 (C) become a state of being distributed in range wider than in FIG. 2. In this case, a cyan display with an area larger than FIG. 2 is performed.

In addition, in a right side of FIG. 2, when the voltage VH (maximum positive voltage) is applied to the second pixel electrode 35B, all of the positively charged particles 27 (Y) move to the opposing electrode 37 side and the distribution region in the plane which is parallel to the second substrate 31 also becomes large. Here, a yellow display is performed.

In addition, when the voltage Vh which is smaller than the voltage VH is applied to the second pixel electrode 35B, since the voltage between the electrodes becomes smaller than the state of the right side of FIG. 2, the electric field generated between the electrodes becomes small, and less of the positively charged particles 27 (Y) than in the state of the right side of FIG. 2 move to the second substrate 31 side. Furthermore, since the original electric field becomes small, according to this, the inclined electric field also becomes small, and the amount of movement of the positively charged particles 27 (Y) is small in the direction which is parallel to the second substrate 31, and the positively charged particles 27 (Y) become a state of being distributed in range narrower than in FIG. 2. In this case, a yellow display with an area smaller than FIG. 2 is performed.

In addition, for example, by applying the voltage VH to the first pixel electrode 35A and applying the voltage VL to the second pixel electrode 35B, the negatively charged particles 26 (C) are drawn to the first electrode 35A side and the positively charged particles 27 (Y) are drawn to the second pixel electrode 35B. In this case, by the non-charged particles 28 (M) with a magenta color being distributed on the opposing electrode 37 side relatively more than the negatively charged particles 26 (C) and the positively charged particles 27 (Y), the non-charged particles 28 (M) with a magenta color are visually recognized from the second substrate 31 side and the display of one pixel is magenta.

The point here is that three particles of each color (CMY) are used in the dispersion medium by being divided into positive, negative, and non-charged particles. The first pixel electrode 35A and the second pixel electrode 35B with a small area compared to the opposing electrode 37 are used with regard to each of the negatively charged particles 26 (C) and the positively charged particles 27 (Y), and the distribution of the particles on the opposing electrode 37 is controlled corresponding to the polarity of the voltage applied to each of the pixel electrodes. Here, it is possible to control the distribution of the particles on the opposing electrode 37 by not only the size of the voltage but also the length of time the voltage is applied.

The negatively charged particles 26 (C) with a cyan color lower a R wavelength with regard to transparent particles, transmits B and G light, and absorbed R light. Alternatively, it is sufficient if there is a degree of reflectivity in the particle surface with regard to B and G light. That is, it is sufficient if the particles are semi-transparent. For example, the particles are configured to have a transparent portion and a colored portion, and the reflectivity and transparency of the colored portion differs due to the wavelength. The particles of a magenta color and a yellow color are the same.

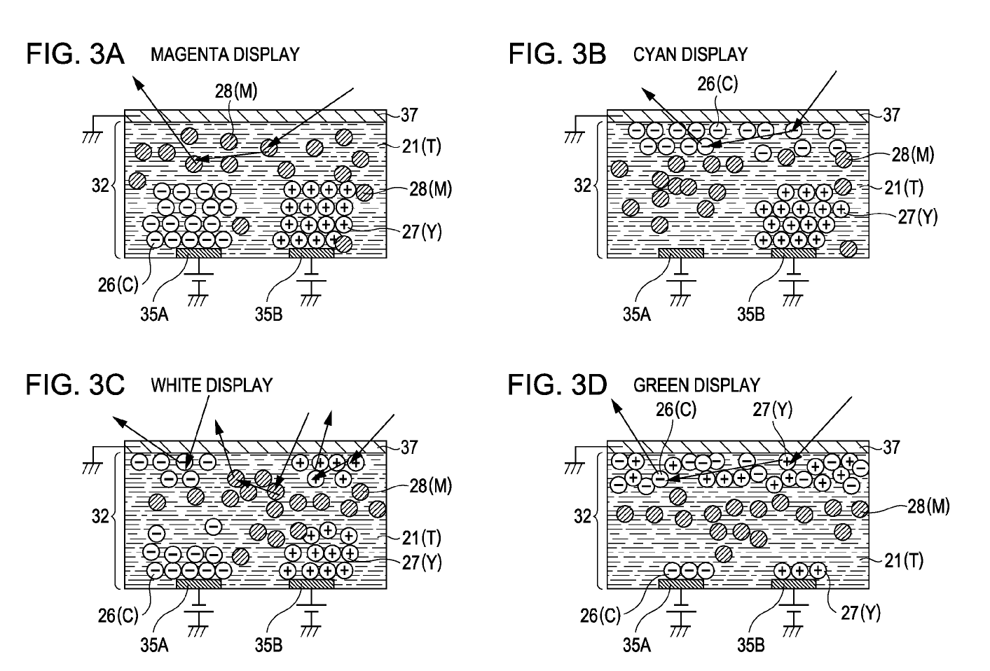

In FIGS. 3A to 3D, an operating principle of the electrophoretic display device which uses three particles is shown.

The electrophoretic layer 32 of the electrophoretic display device holds the negatively charged particles 26 (C) with a cyan color which have a negative charge, the positively charged particles 27 (Y) with a yellow color which have a positive charge, and the non-charged particles 28 (M) with a magenta color in the transparent dispersion medium 21 (T). In the electrophoretic layer 32 side of the second substrate 31, the opposing electrode 37 is formed over substantially the entire display area, and in the electrophoretic layer 32 side of the first substrate 30, a plurality of the first pixel electrodes 35A and the second pixel electrodes 35B are formed for each one pixel (one each is shown in the diagram of FIG. 3). The first pixel electrode 35A and the second pixel electrode 35B are formed to be smaller than the opposing electrode 37.

FIG. 3A shows a state when displaying magenta.

Here, the positive voltage VH is applied to the first pixel electrode 35A and the negative voltage VL is applied to the second pixel electrode 35B. Then, the negatively charged particles 26 (C) which have a negative charge are adsorbed to the first pixel electrode 35A and the positively charged particles 27 (Y) which have a positive charge are adsorbed to the second pixel electrode 35B. The light which is incident from the outside (shown by the arrow in the diagram. The same applies below.) exits from the opposing electrode 37 side with a magenta color since the blue and red wavelength components are scattered by the non-charged particles 28 (M) with a magenta color which are suspended in the transparent dispersion medium 21.

FIG. 3B shows a state when displaying cyan.

Here, from a state of FIG. 3A, the negative voltage VL is applied to the first pixel electrode 35A and the second pixel electrode 35B. Then, all of the negatively charged particles 26 (C) which have a negative charge move to the opposing electrode 37 side. On the other hand, the positively charged particles 27 (Y) which have a positive charge are adsorbed to the second pixel electrode 35B. The light which is incident from the outside exits from the opposing electrode 37 side with a cyan color since the blue and green wavelength components are scattered by the negatively charged particles 26 (C) which are distributed on the opposing electrode 37.

FIG. 3C shows a state when displaying white.

Here, first, from a state shown in FIG. 3A, a voltage is applied to the first pixel electrode 35A and the second pixel electrode 35B. Specifically, a negative voltage VII with an absolute value smaller than the negative voltage VL described above is applied in the first pixel electrode 35A, and a positive voltage Vh1 with an absolute value smaller than the positive voltage VH described above is applied in the second pixel electrode 35B. Then, a portion of the negatively charged particles 26 (C) on the first pixel electrode 35A move to the opposing electrode 37 side, and a portion of the positively charged particles 27 (Y) on the second pixel electrode 35B move to the opposing electrode 37 side. A small cyan dot, a small yellow dot, due to the negatively charged particles 26 (C) and the positively charged particles 27 (Y) distributed on the opposing substrate 37, and the non-charged particles 28 (M), which are distributed between the negatively charged particles 26 (C) and the positively charged particles 27 (Y), each occupy ⅓ of the area of the pixel. In the case of this state, the incident light becomes white display light since each of the wavelengths of RGB is reflected in an amount which is substantially the same.

FIG. 3D shows a state when displaying green.

Here, first, from a state shown in FIG. 3A, a voltage is applied to the first pixel electrode 35A and the second pixel electrode 35B. Specifically, a negative voltage V12 with an absolute value which is smaller than the voltage VL and larger than the voltage V11 is applied in the first pixel electrode 35A, and the negatively charged particles 26 (C) are distributed on the opposing substrate 37. At the same time, a positive voltage Vh2 with an absolute value which is smaller than the voltage VH and larger than the voltage Vh1 is applied in the second pixel electrode 35B, and the positively charged particles 27 (Y) are distributed on the opposing substrate 37.

Then, the negatively charged particles 26 (C) and the positively charged particles 27 (Y) are each distributed in a range wider than the case of the white display and overlap on the opposing electrode 37. The light which is incident from the outside is scattered by the particles of both the negatively charged particles 26 (C) and the positively charged particles 27 (Y), and at this time, the R and B light are absorbed relatively more. As a result, G light exits the surface.

The point here is that a mixed color is expressed by the particles of each of CMY overlapping (being mixed) with each other in a portion of the area. However, as shown in FIG. 3D, it is not necessary for the particles of the negatively charged particles 26 (C) and the positively charged particles 27 (Y) to be mixed in the entire surface of the opposing electrode 37. For example, in the case of displaying green, it is possible to display G even if the negatively charged particles 26 (C) and the positively charged particles 27 (Y) are mixed only in a portion of the area and the other regions are single color areas of each of CMY (including white). At this time, pale (low saturation) green is displayed. Furthermore, similar to when white is displayed previously, it is possible to display a paler green even when the negatively charged particles 26 (C) and the positively charged particles 27 (Y) are in different areas.

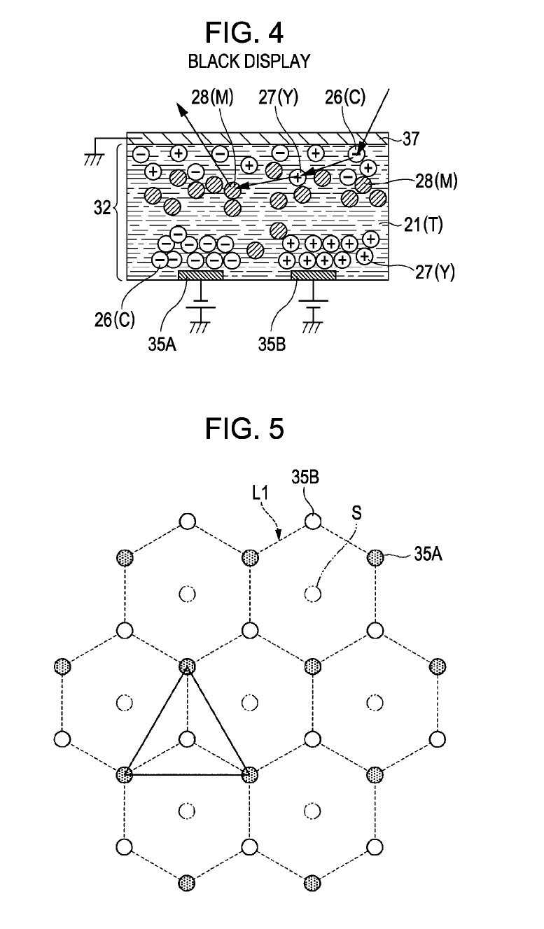

An operation in a case when black is displayed will be described using FIG. 4.

In FIG. 4, with FIG. 3A as a starting point, first, a small negative voltage V13 is applied to the first pixel electrode 35A and a small positive voltage Vh3 is applied to the second pixel electrode 35B. The size of the applied voltages at this time is between the sizes of the voltages applied in FIGS. 3C and 3D, and the absolute values has a relationship where |V11|<|V13|<|V12| and Vh1<Vh3<Vh2. Then, the particles of the three colors of CMY are in effect substantially uniformly distributed on the opposing electrode 37. Since the light which is incident from the outside is transmitted and scattered in turn by the particles of each of the colors of CMY, components of all of the RGB wavelengths are substantially uniformly absorbed. As a result, the reflected light becomes black. After that, when a positive voltage is applied to the first pixel electrode 35A and a negative voltage is applied to the second pixel electrode 35B, it is possible to return to a magenta display of FIG. 3A.

As above, by the first pixel electrode 35A and the second pixel electrode 35B being independently driven, the electrophoretic display device 100 realizes gradation by controlling the area of the particles of each of the colors of CMY which are visually recognized when viewed from the opposing electrode 37 side. Here, it is not limited to the number of particles being few and each of the colors of CMY being completely expressed in the boundaries of the distribution regions of the particles of each of CMY. However, even in these regions, there is an extent of contribution with regard to the display of each of the colors of CMY. Control of the gradation is performed using the effective area which is visually recognized and includes the extent of contribution of the regions such as this, that is, the effective distribution area of the particles. In addition, in order for there to be each color of CMY and mixing of the colors using the particles, since it is necessary the incident light to be scattered by the particles a plurality of times, it is necessary for there to be a three-dimensional distribution in the depth direction in the electrophoretic layer 32. The visually recognized area described above refers to an effective area which is actually visually recognized and includes the two-dimensional and three-dimensional distribution of the particles. In this manner, in the electrophoretic display device 100, gradation control is performed using the effective area of the particles viewed from the opposing electrode 37 side. The gradation indicated here is the effective shading of color created by the color particles. Using this, it is possible to control the brightness, saturation, and chromaticity of mixed colors.

In FIGS. 3C to 4, the voltage for simultaneous rewriting is applied to the first pixel electrode 35A and the second pixel electrode 35B but the voltage may be applied to each electrode sequentially. Sequentially applying may be the applying to each electrode by providing a time difference in one frame or may be executing sequential application using a plurality of frames. For example, a voltage may be applied to the first pixel electrode 35A in a certain frame and a voltage may be applied to the second pixel electrode 35B in the next frame.

Here, as shown in FIGS. 3D and 4, when expressing a mixed color of 2 or 3 colors, it is not a configuration where the particles have 100% transparency but a mixed color is effectively performed with a degree of reflectivity. For example, when transparency is close to 100%, it is necessary that the incident light is reflected by numerous refractions and the like before it is output from the front and it is necessary that there is a thick particles layer for outputting the light from the front. The creating of a thick particles layer on the entire surface of the opposing electrode 37 side is not effective also in terms of energy. In addition, when the particles layer is thin, light reaches the bottom of a cell without being output from the front, a normally unnecessary particle color is perceived, and unnecessary mixed color is generated. Instead of this, giving the particles a degree of reflectivity and leading the light to the front in a particle layer which is not thick is easier to perform mixed color.

FIG. 5 is an explanatory diagram illustrating the distribution of the pixel electrodes in one pixel.

On the first substrate, the first pixel electrode 35A, the second pixel electrode 35B, and a no-electrode-formed region S are provided. The electrodes 35A and 35B and the region S are each distributed uniformly in one pixel. Here, in order to describe a principle, the electrodes 35A and 35B and the region S are set as a repeated pattern in one direction. The plurality of first pixel electrodes 35A in one pixel are supplied with the same signal and the plurality of second pixel electrodes 35B in one pixel are supplied with the same signal. As such, the negatively charged particles 26 (C) and the positively charged particles 27 (Y) are moved corresponding to either the first pixel electrode 35A or the second pixel electrode 35B. In addition, since the non-charged particles 28 (M) with a magenta color do not move irrespective of the signal supplied to the first pixel electrode 35A or the second pixel electrode 35B, there is no corresponding electrode.

Specifically, the base is a layout where three of each of the first pixel electrode 35A and the second pixel electrode 35B are used and each traces out an equilateral triangle. Here, the basic layouts of each of the first pixel electrode 35A and the second pixel electrode 35B are combined and there is a pattern arranged so that there is a hexagon (first layout L1). Each of the electrodes 35A and 35B are positioned at the six apexes of the hexagon and are alternately arranged so that the adjacent pixel electrodes are different.

The no-electrode-formed region S is positioned in the center of the arrangement of the six electrodes 35A and 35B arranged in a hexagonal shape.

In other words, in the vicinity of each first pixel electrode 35A, three of the second pixel electrodes 35B are arranged to form an equilateral triangle so that the position of the first pixel electrode 35A is the center, and in addition, in the vicinity of each second pixel electrode 35B, three of the first pixel electrodes 35A are arranged to form an equilateral triangle so that the position of the second pixel electrode 35B is the center. Furthermore, in the vicinity of each first pixel electrode 35A and each second pixel electrode 35B, three no-electrode-formed regions S are positioned so that the positions of the first pixel electrode 35A and the second pixel electrode 35B are the center.

It is not limited to the arrangement of the electrodes 35A and 35B being a hexagon and there may be other arrangement formations as long as the electrodes 35A and 35B and the no-electrode-formed region S are arranged to be uniformly spaced from each other.

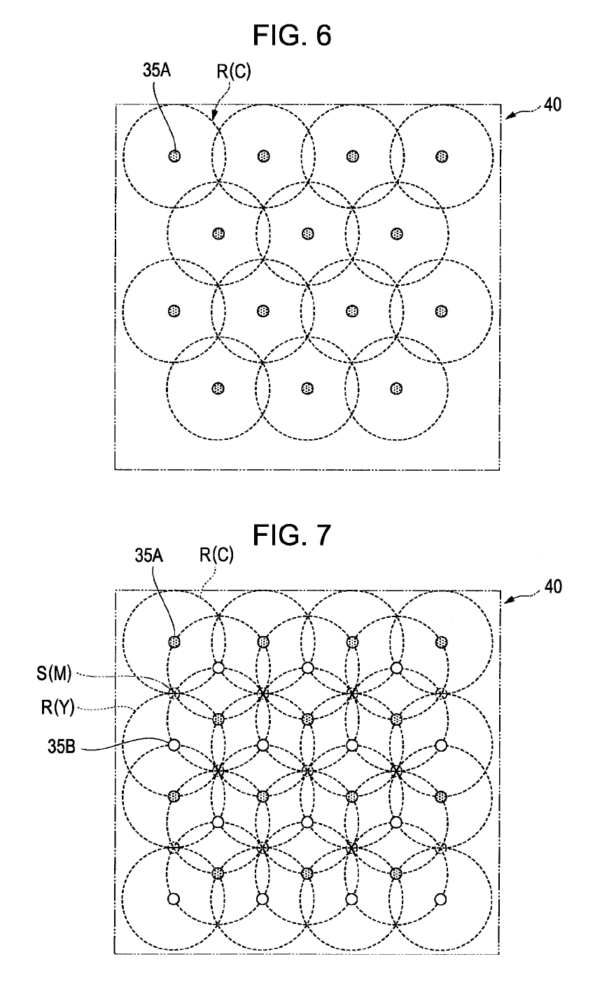

FIG. 6 is a diagram illustrating the distribution state of the cyan particles when displaying cyan.

When a negative voltage is applied to the first pixel electrode 35A, the negatively charged particles 26 (C) with a cyan color which have a negative charge all move to the opposing electrode 37 side, and the negatively charged particles 26 (C) are distributed in a planar circular formation region (distribution region R (C)) with the first pixel electrode 35A as the center. The plurality of distribution regions R (C) formed on the first pixel electrodes 35A partially overlap with each other.

In this manner, by a cyan particle layer being formed in the entire surface of the opposing electrode 37, the light which is incident from the outside is reflected by the cyan particles, become cyan, and is output to the outside. Accordingly, cyan is displayed.

FIG. 7 is a diagram illustrating the distribution state of the cyan particles, the yellow particles, and the magenta particles when displaying black.

As shown in FIG. 7, the cyan particles and the yellow particles are distributed up until the vicinity of the adjacent pixel electrode 35A (35B). The distribution region R (C) of the cyan particles distributed on the first pixel electrode 35A are spread out up until the adjacent second pixel electrode 35B and a distribution region R (Y) of the yellow particles distributed on the second pixel electrode 35B are spread out up until the adjacent first pixel electrode 35A. The magenta particles are distributed, for example, in gaps between the cyan particles and the yellow particles and on a lower layer side of the cyan particles and the yellow particles.

In this manner, the cyan particles, the yellow particles, and the magenta particles are distributed so as to overlap each other in the entire surface of the opposing electrode 37. As a result, the light which is incident from the outside is absorbed by each of the particles, becomes black, and black is displayed.

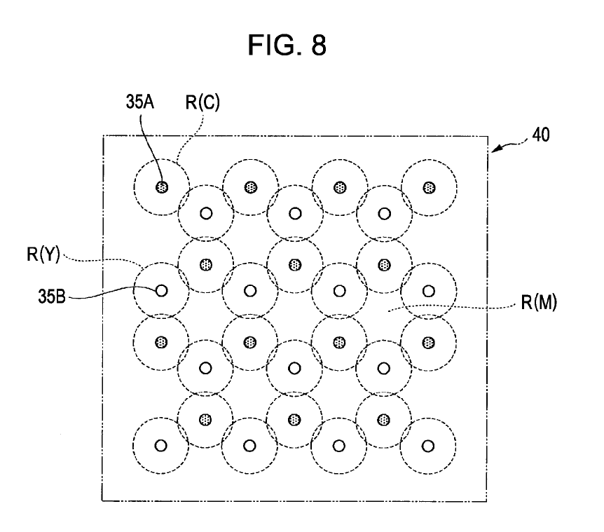

FIG. 8 is a diagram illustrating the distribution state of the cyan particles, the yellow particles, and the magenta particles when displaying white.

As shown in FIG. 8, when a smaller voltage is applied than the voltage applied when the first pixel electrode 35A and the second pixel electrode 35B respectively display cyan and yellow, distribution regions R (C) and R (Y) are formed with smaller areas than the distribution areas shown in FIG. 7. The total area of the distribution regions R (C) and R (Y) of the cyan particles and the yellow particles each take up ⅓ of the area of one pixel. The magenta particles are distributed in a region which includes the gaps between the distribution regions R (C) and R (Y) of the cyan particles and the yellow particles, so that, in the region, the magenta particles are in a state of being exposed to the opposing substrate 37 side. The area of the region where the magenta particles are exposed is also approximately ⅓ of the area of one pixel.

In this manner, by each of the cyan particles, the yellow particles, and the magenta particles being mixed up substantially uniformly in the entire surface of the opposing electrode 37, the light which is incident from the outside is reflected by each of the particles, becomes white, and exits to the outside.

FIG. 9 is an equivalent circuit diagram of the electrophoretic display device.

As shown in FIG. 9, the two selection transistors TR1 and TR2 are provided in one pixel in the electrophoretic display device of the embodiment. A pixel circuit in one pixel each has a configuration which includes the electrophoretic layer 32 as an electro-optic material and the selection transistors TR1 and TR2 which perform a switching operation for supplying a voltage to the electrophoretic layer 32. It is possible to perform an image display with no crosstalk by independently controlling the application of a voltage to the first pixel electrode 35A and the second pixel electrode 35B using the two selection transistors TR1 and TR2.

The gate of the selection transistor TR1 is connected to the scanning line 66 (first scanning line), the source of the selection transistor TR1 is connected to a data line 68A (first data line), and the drain of the selection transistor TR1 is connected to the electrophoretic layer 32. The gate of the selection transistor TR2 is connected to the scanning line 66 (second scanning line), the source of the selection transistor TR2 is connected to a data line 68B (second data line), and the drain of the selection transistor TR2 is connected to the electrophoretic layer 32. Specifically, out of the pixels 40A and 40B which are adjacent in the column direction, in the pixel 40A, the gates of each of the selection transistors TR1 and TR2 are connected to an m row of the scanning line 66. In addition, the source of the selection transistor TR1 is connected to an N (A) row of the data line 68A and the drain of the selection transistor TR1 is connected to the electrophoretic layer 32. On the other hand, the source of the selection transistor TR2 is connected to an N (B) row of the data line 68B and the drain of the selection transistor TR2 is connected to the electrophoretic layer 32.

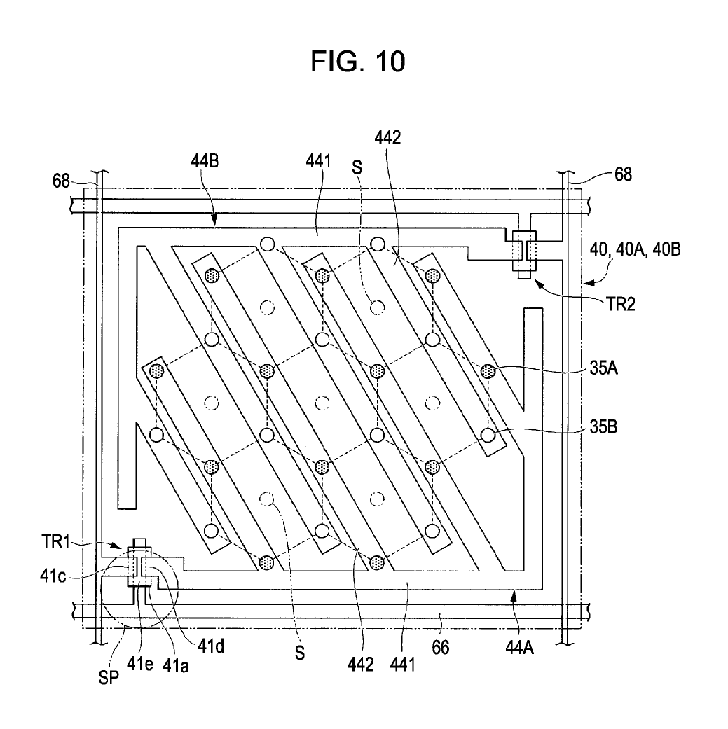

Here, the drain of the selection transistor TR1 is connected to the electrophoretic layer 32 via a first connection electrode 44A (FIG. 10) and the drain of the selection transistor TR2 is connected to the electrophoretic layer 32 via a second connection electrode 44B (FIG. 10).

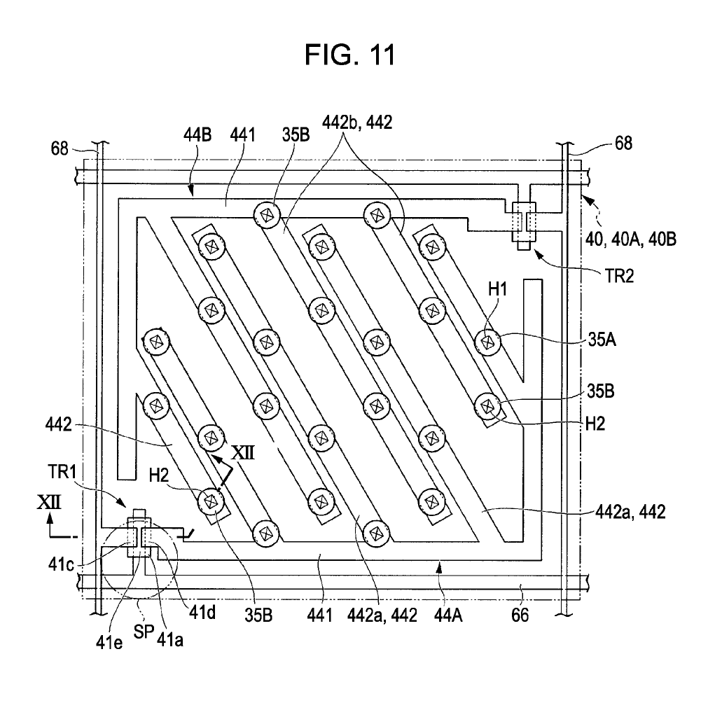

FIG. 10 is a planar diagram illustrating a schematic configuration of one pixel. FIG. 11 is a planar diagram illustrating a specific configuration example of one pixel.

As shown in FIGS. 10 and 11, the plurality of first pixel electrodes 35A, the plurality of second pixel electrodes 35B, and the no-electrode-formed regions S are arranged with uniform gaps therebetween in the one pixel 40. In addition, the plurality of first pixel electrodes 35A are mutually connected by the first connection electrode 44A formed in a layer further to the first substrate 30 side than the plurality of first pixel electrodes 35A, and the plurality of second pixel electrodes 35B are mutually connected by the second connection electrode 44B formed in a layer further to the first substrate 30 side than the plurality of second pixel electrodes 35B.

The first connection electrode 44A and the second connection electrode 44B are planar pectinate shapes and are respectively connected to drain electrodes 41d of the selection transistor TR1 and the selection transistor TR2 which are formed in the pixel. That is, the first connection electrode 44A and the second connection electrode 44B are positioned in the same layer as the respective drain electrodes 41d of the selection transistor TR1 and TR2 and are formed integrally with the respective drain electrodes 41d.

In the first connection electrode 44A, the first pixel electrode 35A is connected via a contact hole H1, and in the second connection electrode 44B, the second pixel electrode 35B is connected via a contact hole H2 (FIG. 11).

In the embodiment, a voltage is supplied to each of the connection electrodes 44A and 44B and each of the pixel electrodes 35A and 35B via the selection transistor TR1 and the selection transistor TR2 by the scanning lines 66 being sequentially selected.

Each of the connection electrodes 44A and 44B are formed on two sides which extend along the two directions (for example, the extending direction of the scanning lines 66 or the data lines 68) described above, and have a trunk portion 441 which is angled and a plurality of branch portions 442 which are connected by the trunk portion 441. The plurality of branch portions 442 extends in parallel to each other in a different direction to the extending direction of the trunk portion 441 (here, a direction which is approximately 60° with regard to each side of the branch portions 442. The direction is not limited to this and it is possible for the direction to be, for example, a direction of 45°), and the extending lengths of all of the branch portions 442 are different. The branch portions 442, which extend from the vicinity of the angle portion (bent portion) of the trunk portion 441, are the longest and become shorter lengths for the branch portions 442 farther away from the trunk portion 441. Each of the connection electrodes 44A and 44B has a pectinate shape and are arranged in the pixel 40 to mesh with each other. That is, in a state where branch portions 442b and 442b of the second connection electrode 44B exist on both sides of a branch portion 442a of the first connection electrode 44A. Here, the branch portion 442a of the first connection electrode 44A is formed to be closer to one side out of the branch portions 442b and 442b of the second connection electrode 44B which exist on both sides of the branch portion 442a.

Each of the branch portions 442a of the first connection electrode 44A corresponds to a plurality of first pixel electrodes 35A and each of the branch portions 442b of the second connection electrode 44B corresponds to a plurality of second pixel electrodes 35B.

In addition, the no-electrode-formed regions S corresponding to non-charged particles are positioned between specified branch portions 442 of the first connection electrode 44A and the second connection electrode 44B (FIG. 10). Of course, the first connection electrode 44A and the second connection electrode 44B may be arranged in the positions corresponding to the no-electrode-formed regions S.

In the embodiment, a plurality of each of the first pixel electrodes 35A and the second pixel electrodes 35B formed in island shapes are provided for each pixel, and the total area of the first pixel electrode 35A and the second pixel electrode 35B of one pixel is equal to or less than ¼ of the area of one pixel.

Here, in a case where the electrophoretic layer 32 included in a pixel is partitioned by a sealing material, it is possible that the pixel area is the area of the region partitioned by the sealing material. In addition, in a case where the electrophoretic layer 32 included in a pixel is not partitioned by a sealing material, it is possible to define the pixel area as an area determined by the product of the arrangement pitch of the scanning lines 66 connected to the selection transistor TR1 and the arrangement pitch of the data lines 68 connected to the selection transistor TR1.

As shown in FIG. 11, the first pixel electrode 35A and the second pixel electrode 35B are formed to be intermingled with each other in predetermined intervals so as not to overlap in the same pixel area. The first pixel electrode 35A and the second pixel electrode 35B are formed in a circular shape in a planar view. The diameters of the electrodes 35A and 35B are formed in dimensions smaller than a cell gap (distance between the opposing electrode 37 and the first pixel electrode 35A or the second pixel electrode 35B), and it is preferable for the diameter to be equal to or less than ½ of the cell gap. According to this, it is possible to reduce the size of the display dot on the opposing electrode 37 and pale color display is possible. This broadens the range of colors which are able to be expressed.

In addition, the shape of each of electrodes 35A and 35B are not limited to the circular shape, but may be a polygonal shape.

A spacer SP for maintaining a gap between the element substrate 300 and the opposing substrate 310 has a thickness (height) of 40 μm with a column shape using photosensitive acrylic, and is used in a ratio of one for every plurality of pixels 40.

In the embodiment, the plurality of island-shaped pixel electrode 35A and 35B are formed in one pixel. Using the plurality of pixel electrode 35A and 35B, it is possible to more effectively perform the mixing of the particles on the opposing electrode 37 and to effectively perform color mixing.

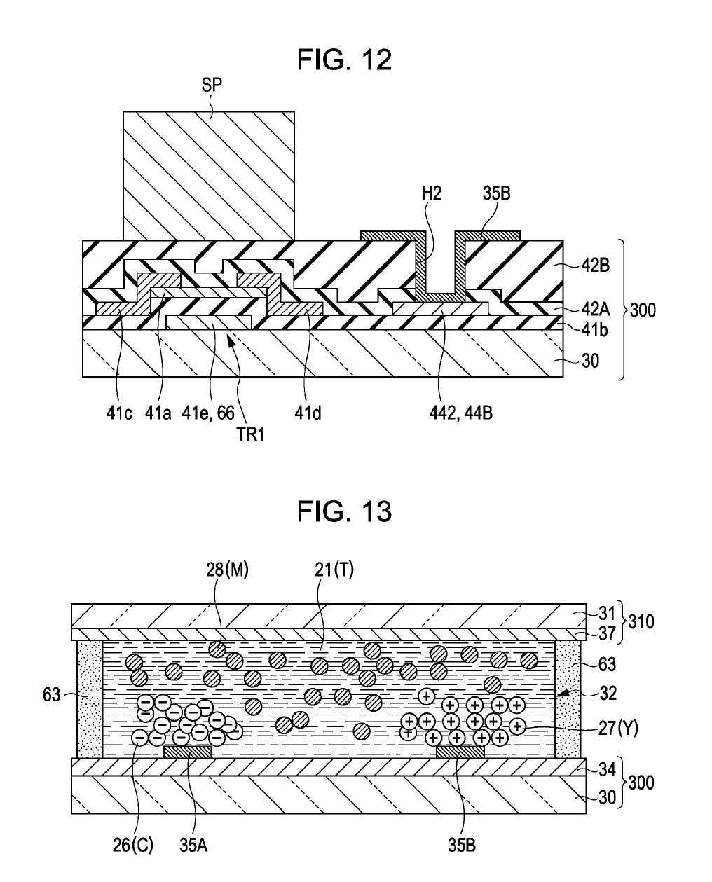

FIG. 12 is a cross-sectional diagram along a line XII-XII of FIG. 11.

As shown in FIG. 12, the first substrate 30 is formed from a glass substrate with a thickness of 0.6 mm, and on the surface thereof, a gate electrode 41e (scanning line 66) is formed from aluminum (Al) with a thickness of 300 nm. Then, a gate insulating film 41b is formed from a silicon oxide film on the entire surface of the first substrate 30 so as to cover the gate electrode 41e, and a semiconductor layer 41a is formed from a-IGZO (an oxidation product of In, Ga, and Zn) with a thickness of 50 nm directly on the gate electrode 41e.

On the gate insulating film 41b, a source electrode 41c (data line 68) and a drain electrode 41d formed from Al with a thickness of 300 nm are each provided so as to partially overlap with the gate electrode 41e and the semiconductor layer 41a. The source electrode 41c and the drain electrode 41d are formed so a portion sits on top of the semiconductor layer 41a. A connection electrode 44 formed from aluminum (Al) with the same thickness of 300 nm is formed on the gate insulating film 41b. Since the connection electrode 44 is patterned and formed at the same time as the source electrode 41c and the drain electrode 41d, the connection electrode 44 is connected to the drain electrode 41d.

Here, as the selection transistor TR1 (TR2), it is possible to use a typical a-Si TFT, poly SiTFT, organic TFT, oxide TFT, or the like. It is possible to use either a top gate or a bottom gate configuration.

On the selection transistor TR1 (TR2) and the connection electrode 44, an interlayer insulating film 42A is formed from a silicon oxide film with a thickness of 300 nm and an interlayer insulating film 42B is formed from photosensitive acrylic with a thickness of 1 μm so as to cover the selection transistor TR1 (TR2) and the connection electrode 44. The interlayer insulating film 42B functions as a planarization film. In addition, if it is possible to apply a planarization film function to the interlayer insulating film 42A, the interlayer insulating film 42B is not necessarily necessary and it is possible for the interlayer insulating film 42B not to be included. Then, the plurality of pixel electrodes 35B (35A) which is formed from ITO with a thickness of 50 nm is provided via the contact hole H2 (H1) formed in the interlayer insulating film 42A and the interlayer insulating film 42B. The element substrate 300 is configured by the components from the first substrate 30 to the pixel electrodes 35B (35A).

Then, the spacer SP described above is formed on the top surface of the first substrate 30.

FIG. 13 is a cross-sectional diagram illustrating a schematic configuration of one pixel of the electrophoretic display device.

As shown in FIG. 13, the electrophoretic display device of the embodiment has the electrophoretic layer 32 interposed between the first substrate 30 and the second substrate 31, a circuit layer 34 which includes the selection transistors, other wirings, and the like, the plurality of first pixel electrodes 35A, and the plurality of second pixel electrodes 35B are provided on the electrophoretic layer 32 side of the first substrate 30, and the opposing electrode 37 is provided on the electrophoretic layer 32 side of the second substrate 31. The opposing substrate 37, which faces the plurality of first pixel electrodes 35A and the plurality of second pixel electrodes 35B, has an area wider than the total area of the first pixel electrodes 35A and the second pixel electrodes 35B with island shapes, and is a continuous electrode (electrode with no gaps) at least in the region which contributes to the display in the pixel. In the opposing electrode 37, a notch portion where there are no electrodes may be provided corresponding to requirements. The first pixel electrode 35A and the second pixel electrode 35B in one pixel are driven independently from each other.

In more detail, the electrophoretic layer 32 is interposed between the element substrate 300, which includes the first substrate 30, the circuit layer 34, the first pixel electrodes 35A, and the second pixel electrodes 35B, and the opposing substrate 310 which includes the second substrate 31 and the opposing electrode 37. Between the element substrate 300 and the opposing substrate 310, a sealing material 63 is formed which is arranged to enclose the entire periphery of the display portion 5 (FIG. 1A) in a planar view. The electrophoretic layer 32 is encapsulated by the element substrate 300, the opposing substrate 310, and the sealing material 63. In addition, it is possible for the sealing material to be formed between the element substrate 300 and the opposing substrate 310 so as to enclose each pixel in a planar view.

In addition, although not shown in the diagram, it is possible for a capsule to be arranged between the pixel electrodes and the opposing electrode and an electrophoretic layer of a capsule-type where a dispersion medium and charged particles are encapsulated in the capsule. Even in the capsule-type electrophoretic layer such as this, it is possible to perform operations similar to the other applied examples.

The electrophoretic layer 32 holds a plurality of each of the three types of particles in the dispersion medium 21 (T) which is colorless and transparent. As the three types of particles, there are the negatively charged particles 26 (C) with a cyan color which have a negative charge, the positively charged particles 27 (Y) with a yellow color which have a positive charge, and the non-charged particles 28 (M) with a magenta color.

The constituent material of the transparent electrodes used in the opposing electrode 37, the first pixel electrode 35A, and the second pixel electrode 35B is not particularly limited as long as the material has conductivity in practice, but for example, there are various types of conductive materials such as metallic materials such as copper, aluminum, or an alloy including copper and aluminum, carbon-based materials such as carbon black, electronically conductive polymer materials such as polyacetylene, polypyrrole or a conductor of polyacetylene and polypyrrole, ion conductive polymer materials such as an ionic material such as NaCl, LiClO₄, KCl, LiBr, LiNO₃, or LiSCN dispersed in a matrix resin such as polyvinyl alcohol, polycarbonate, or polyethylene oxide, or conductive oxide materials such as indium tin oxide (ITO), fluorine-doped tin oxide (FTO), tin oxide (SnO₂), or indium oxide (IO), and it is possible to use one type or a combination of two or more types.

In addition, as the electrode material of the first pixel electrode 35A and the second pixel electrode 35B, it is not necessary for the materials to be transparent since the electrodes are positioned on a side opposite to the visually recognized side, and for example, a paste of a metal, a silicide, silver, or the like may be used.

As the material for the dispersion medium 21, it is preferable that it is colorless and transparent in practice. As such a dispersion medium, a material with relatively high insulating properties is suitably used. As the dispersion medium, there are various types of water (distilled water, pure water, ion-exchange water, or the like), alcohols such as methanol, ethanol, or butanol, cellosolves such as methyl cellosolve, esters such as methyl acetate or ethyl acetate, ketones such as acetone or methyl ethyl ketone, aliphatic hydrocarbons such as pentane, alicyclic hydrocarbons such as cyclohexane, aromatic hydrocarbons such as benzene with a long-chain alkyl group such as benzene or toluene, halogenated hydrocarbons such as methylene chloride or chloroform, aromatic heterocycles such as pyridine or pyrazine, nitriles such as acetonitrile or propionitrile, amides such as N,N-dimethylformamide, mineral oils such as carboxylate or liquid paraffin, vegetable oils such as linoleic acid, linolenic acid, or oleic acid, silicone oils such as dimethyl silicone oil, methyl phenyl silicone oil, or methyl hydrogen silicone oil, fluorine-based liquids such as hydrofluoro ether, or other types of oils, and it is possible to use one or a combination. As the dispersion medium 21, a gas or a vacuum may be used.

In addition, in the dispersion medium 21, various types of additives such as electrolytes, surfactants, metallic soaps, resins, rubber, oils, varnishes, charge control agents formed from particles such as compounds, dispersants such as titanium-based coupling agents, aluminum-based coupling agents, and silane-based coupling agents, lubricants, and stabilizers may be added as required.

For the charged particles, non-charged particles, and transparent particles included in the dispersion medium 21, it is possible to use various materials for each, and while not particularly limiting, at least one type of dye particles, pigment particles, resin particles, ceramic particles, metallic particles, metal oxide particles, or particles which are a combination of these are suitably used. The particles have advantages in that manufacturing is easy and it is possible to relatively easily perform charge control.

As the pigments which configure the pigment particles, there are black pigments such as aniline black, carbon black, or black titanium oxide, white pigments such as titanium dioxide, antimony trioxide, zinc sulfide, or zinc oxide, azo-based pigments such as monoazo, diaso, or polyazo, yellow pigments such as isoindolinone, chrome yellow, yellow iron oxide, cadmium yellow, or titan yellow, red pigments such as quinachrome red or chrome vermillion, blue pigments such as phthalocyanine blue, indanthrene blue, iron blue, ultramarine, or cobalt blue, green pigments such as phthalocyanine green, cyan pigments such as ferric ferrocyanide, or magenta pigments such as inorganic iron oxide. It is possible to use an inorganic pigment or an organic pigment. It is possible to use one type or a combination of two or more types.

It is possible to use a dye instead of the pigments described above and to configure dye particles. In this case, a dye may be used by being mixed with a white pigment or mixed with a colored pigment. For example, it is possible to use a dye such as a carbonium-type magenta.

In addition, as the resin material which configures the resin particles, there are acrylic resins, urethane resins, urea resins, epoxy resins, rosin resins, polystyrene, polyester, or AS resins which are a copolymer of styrene and acrylonitrile, and it is possible to use one type or a combination of two or more types.

In addition, as compound particles, for example, there are particles which are configured by a resin material covering the surface of pigment particles, a pigment covering the surface of resin particles, or a compound where a pigment and a resin material are mixed in an appropriate composition ratio. In addition, as each type of particle included in the dispersion medium 21, a particle configuration where the centers have been made hollow may be used. According to the configuration such as this, in addition to the surface of the particles scattering light, it is possible that light is also scattered by wall surfaces which configure the hollow inside of the particles and it is possible for the scattering efficiency of light to be improved. As such, it is possible to improve the coloring of white or other colors.

In addition, in order to improve the dispersibility of the electrophoretic particles in the dispersion medium, it is possible to physically adsorb or chemically bond a polymer with a high compatibility with the dispersion medium on the surface of each particle. Out of these, due to the problem of detaching from the surface of the electrophoretic particles, it is particularly preferable if the polymer is chemically bonded. According to the configuration, there is an action in a direction of reducing the specific gravity of the appearance of the electrophoretic particles and it is possible to improve the affinity of the electrophoretic particles to the dispersion medium, that it, the dispersibility.

As a polymer such as this, there are polymers which have a group which has reactivity with the electrophoretic particles and a charged functional group, polymers which have a group which has reactivity with the electrophoretic particles and a long alkyl chain, long ethylene oxide chain, long alkyl fluoride chain, long dimethyl silicone chain, and the like, or polymers which have a group which has reactivity with the electrophoretic particles, a charged functional group, a long alkyl chain, long ethylene oxide chain, long alkyl fluoride chain, long dimethyl silicone chain, and the like.

In the polymers described above, as a group which has reactivity with the electrophoretic particles, there are epoxy groups, thioepoxy groups, alkoxysilane groups, silanol groups, alkylamide groups, aziridine groups, oxazoline groups or isocyanate groups, and it is possible to select and use one type or two or more types, but the selection may be made to correspond to the type of electrophoretic particle used or the like.

The average particle diameter of the electrophoretic particles is not particularly limited, but it is preferable if the average particle diameter is approximately 0.01 to 10 μm and it is more preferable if the average particle diameter is approximately 0.02 to 5 μm.

In addition, acrylic is used as a material of the interlayer insulating films 42A and 42B for securing insulation of the pixel electrodes 35A and 35B and the connection electrodes 44A and 44B. It is possible to use materials other than acrylic, and inorganic insulating films such as a silicon oxide film or organic insulating films are possible.

As the element substrate 300 and the opposing substrate 310, an organic insulating substrate other than a PET substrate, an inorganic glass substrate such as thin glass, or a composite substrate formed from an inorganic substrate and an organic substrate may be used.

### Manufacturing Method of Electrophoretic Display Device

Below, the manufacturing method of the electrophoretic display device will be described.

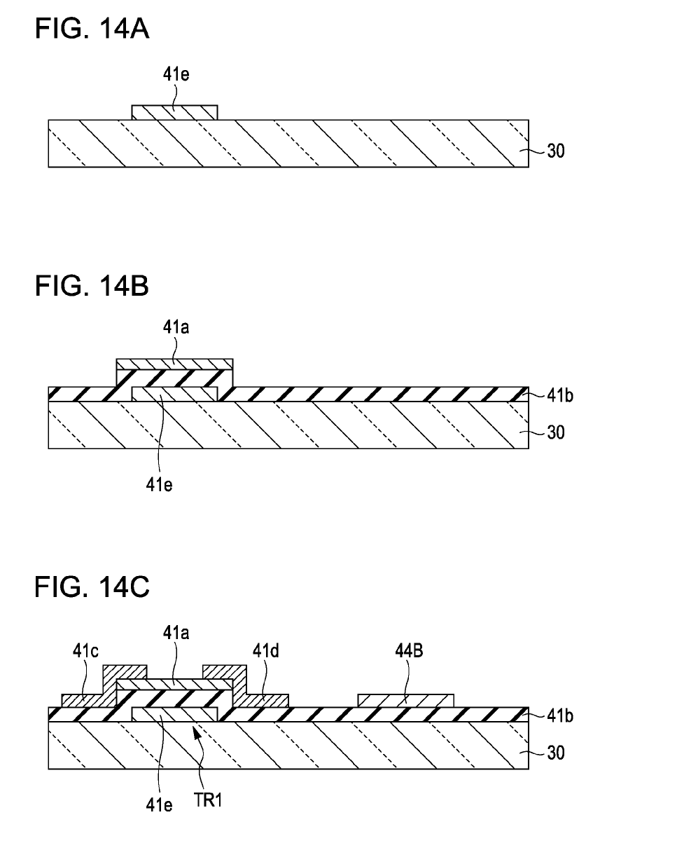

FIGS. 14A to 16 are partial cross-sectional diagrams for describing the manufacturing process of the electrophoretic display device.

First, as shown in FIG. 14A, aluminum (Al) with a thickness of 300 nm is deposited using a sputtering method over the entire substrate surface on the element substrate 300 formed from a glass substrate with a thickness of 0.6 mm, and the gate electrode 41e is formed using a photo etching method.

Next, as shown in FIG. 14B, a silicon oxide film with a thickness of 300 nm is formed over the entire substrate surface using a plasma CVD method and the gate insulating film 41b is formed. After that, on the gate insulating film 41b, the semiconductor layer 41a with a thickness of 50 nm is formed from a-IGZO (an oxidation product of In, Ga, and Zn) using a sputtering method. At this time, processing is performed in an island state using a photo etching process so as to partially remain on the gate electrode 41e. It is known that the source and drain regions of an oxide semiconductor form naturally without, in particular, the introduction of impurities. The introduction of impurities and the like are not performed in the embodiment. In addition, it is not necessary that the formation of the interlayer insulating film 42B and the semiconductor layer 41a is necessarily continuously depositing in a vacuum such as amorphous silicon.

Next, as shown in FIG. 14C, an aluminum (Al) film with a thickness of 300 nm is deposited on the entire surface of the gate insulating film 41b using a sputtering method, the source electrode 41c and the drain electrode 41d are formed and the first connection electrode 44A (not shown) and the second connection electrode 44B are formed by patterning the aluminum film using a photo etching method so as to partially sit on top of the semiconductor layer 41a.

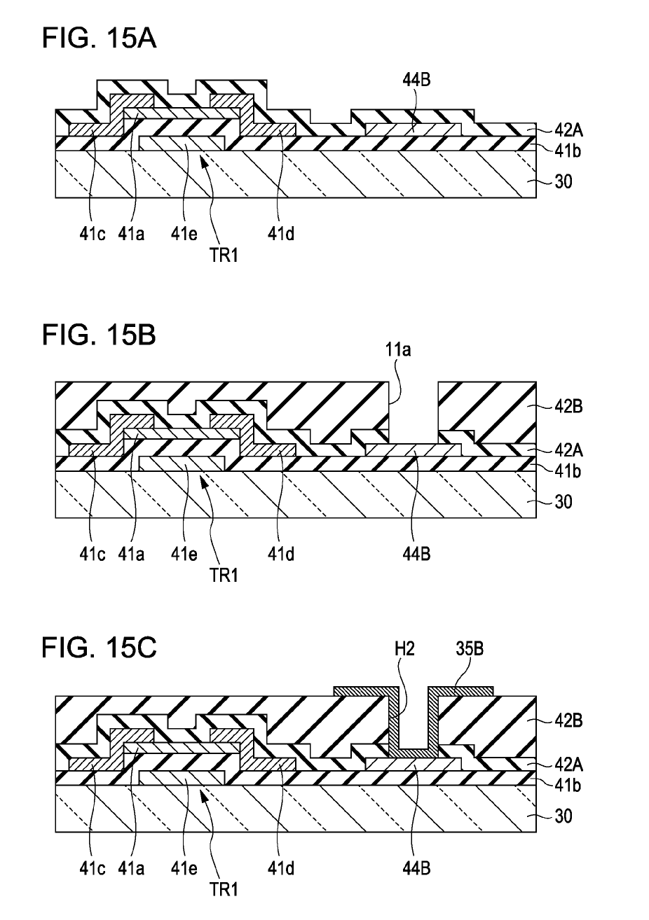

Next, as shown in FIG. 15A, the interlayer insulating film 42A formed from a silicon oxide film with a thickness of 300 nm is formed using a plasma CVD method so as to cover the source electrode 41c, the drain electrode 41d, the first connection electrode 44A, and the second connection electrode 44B.

Next, as shown in FIG. 15B, the interlayer insulating film 42B is formed by applying photosensitive acrylic with a thickness of 1 μm on the interlayer insulating film 42A using a spin coating method. After this, the interlayer insulating film 42A and the interlayer insulating film 42B on the first connection electrode 44A (not shown) and the second connection electrode 44B are partially exposed and developed, and a plurality of through holes 11a is formed which partially expose on the drain electrode 41d.

Next, as shown in FIG. 15C, an ITO film with a thickness of 50 nm is deposited on the entire surface of the interlayer insulating film 42B using a sputtering method, and by performing patterning using a photo etching method, the plurality of pixel electrodes 35B (35A) and the plurality of contact holes H2 (H1) are formed. Via the contact holes H1 and H2, the first pixel electrode 35A is connected to the first connection electrode 44A and the second pixel electrode 35B is connected to the second connection electrode 44B.

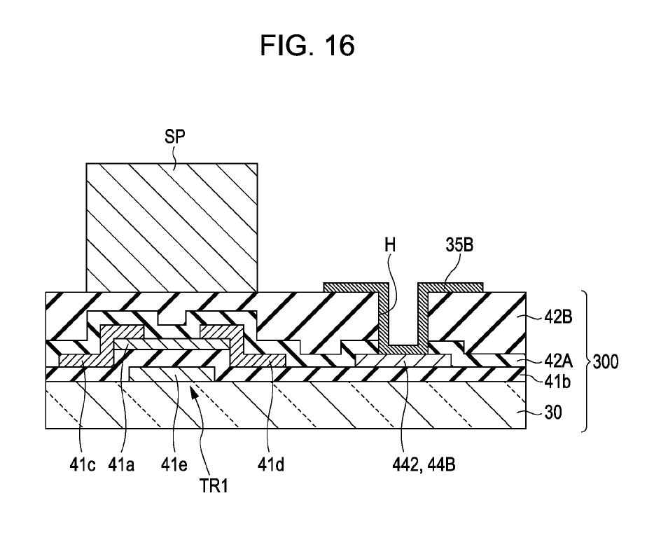

Next, as shown in FIG. 16, the spacer SP with a height of 40 μm is formed on the top surface of the element substrate 300 (interlayer insulating film 42B). Although not shown, next, a sealing material is formed so as to surround the display region on the element substrate 300, and after the application of an electrophoretic material in the region surrounded by the sealing material, the opposing substrate 310 is joined onto the element substrate 300. In this manner, the electrophoretic display device is completed.

The electrophoretic display device 100 of the embodiment is provided with the first substrate 30, the second substrate 31, the electrophoretic layer 32 which is arranged between the first substrate 30 and the second substrate 31 and has at least the dispersion medium 21 and the electrophoretic particles (the negatively charged particles 26 and the positively charged particles 27) and non-charged particles 28 mixed in the dispersion medium 21, the plurality of first pixel electrodes 35A and the plurality of second pixel electrodes 35B which are formed in an island shape on the electrophoretic layer 32 side of the first substrate 30 and are provided in one pixel, the opposing electrode 37 which is formed on the electrophoretic layer 32 side of the second substrate 31 with an area wider than the pixel electrodes 35A and 35B, and has a configuration where the first pixel electrode 35A and the second pixel electrode 35B are driven independently from each other and gradation is controlled using an area of each of the particles described above which are visually recognized when the electrophoretic layer 32 is viewed from the opposing electrode 37 side.

According to the electrophoretic display device 100 such as this, using the polarity, size or the like of the voltage applied to the plurality of first pixel electrodes 35A and the plurality of second pixel electrodes 35B, it is possible to control the movement and the distribution range on the opposing electrode 37 of the negatively charged particles 26 and the positively charged particles 27 mixed in the dispersion medium of the electrophoretic layer 32. In this manner, using the configuration where the plurality of pixel electrodes 35A and 35B are provided in one pixel, it is possible to provide the electrophoretic display device 100 which is a display portion which corresponds from a one-particle system to a three-particle system and performs an excellent color display.

In the embodiment, since it is possible to distribute the negatively charged particles 26 and the positively charged particles 27 in the vicinity of the opposing electrode 37 by applying an arbitrary voltage to the first electrode 35A, the second electrode 35B, and the opposing electrode 37, hue, brightness, and saturation are controlled and a desired display is obtained by controlling the gradation using the effective distribution area of each color of the particles 26, 27 and 28 which are visually recognized when the electrophoretic layer 32 is viewed from the opposing electrode 37 side.

In addition, since the plurality of first pixel electrodes 35A, the plurality of second pixel electrodes 35B, and the no-electrode-formed regions S are arranged with uniform intervals, it is possible to uniformly distribute each of the particles and the layout of the first electrodes 35A and the second electrodes 35B is easy.

In addition, the total area of the first electrode 35A and the second electrode 35B in one pixel provided for each pixel may be equal to or less than ¼ of the area of one pixel, and according to the configuration such as this, it is possible to distribute the particles in small dot regions on the opposing electrode 37, and as a result, it is possible to express more gradations.

In addition, since the same type of electrodes in the pixel 40 is mutually connected in a lower layer side, it is possible to simultaneously apply the same voltage to the same type of electrodes in the pixel 40 and control is easily performed.

In addition, since the width of the first pixel electrode 35A and the second pixel electrode 35B described above is set to be a shorter dimension than the cell gap, it is possible to perform small dot display on the opposing substrate 37. It is possible to adjust the gradation (color) using the size of the dots. It is preferable for the width of the first pixel electrode 35A and the second pixel electrode 35B to be equal to or less than ½ of the length of the cell gap. According to this, it is possible to perform display with smaller dots and a sharp display is obtained.

In addition, it is possible for the color of the positively charged particles, the negatively charged particles, and the non-charged particles to be arbitrarily selected from CMY.

### Second Embodiment

Next, an electrophoretic display device according to a second embodiment will be described. Below, the parts which differ from the first embodiment will be described. The other parts are similar to the first embodiment.

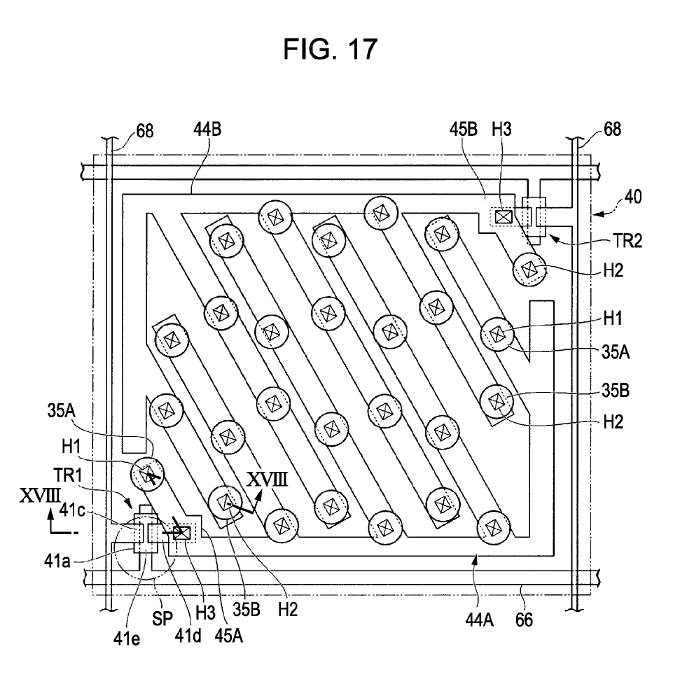

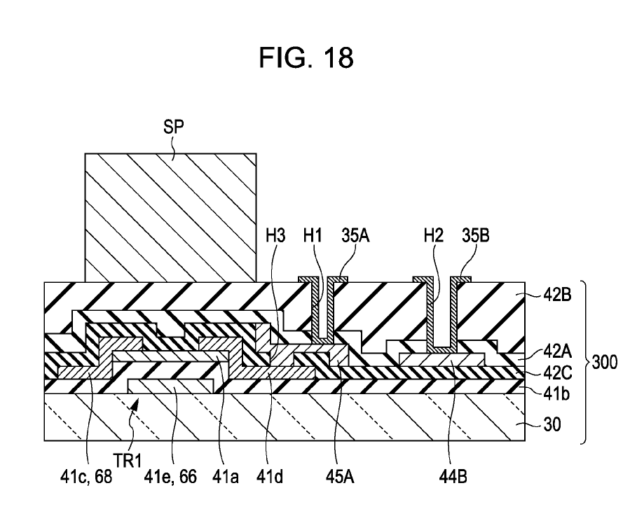

FIG. 17 is a planar diagram illustrating a schematic configuration of one pixel according to the second embodiment, and FIG. 18 is a cross-sectional diagram along a line XVIII-XVIII of FIG. 17.

The electrophoretic display device according to the second embodiment is provided with the plurality of first pixel electrodes 35A, the plurality of second pixel electrodes 35B, the first connection electrode 44A, the second connection electrode 44B, the selection transistor TR1, and the selection transistor TR2 in one pixel in the same manner as the previous embodiment, but in the embodiment, the further provision of drain connection electrodes 45A and 45B and a interlayer insulating film 42C described later is different.

As shown in FIG. 17, the drain connection electrodes 45A and 45B are respectively provided in the vicinity of each of the selection transistors TR1 and TR2. The drain connection electrode 45A is electrically connected to the drain electrode 41d of the selection transistor TR1 via a contact hole H3. In addition, the drain connection electrode 45A and the first connection electrode 44A are continuously formed in the same layer. The drain connection electrode 45B is electrically connected to the drain electrode 41d of the selection transistor TR2 via the contact hole H3. In addition, the drain connection electrode 45B and the second connection electrode 44B are continuously formed in the same layer.

As shown in FIG. 18, the connection electrodes 44A and 44B are respectively formed in layers different to each of the drain electrodes 41d of the selection transistors TR1 and TR2. The interlayer insulating film 42C is formed on the selection transistor TR1 (TR2) formed on the element substrate 300, and on the surface thereof, the drain connection electrode 45A (45B), which is patterned and formed at the same time as the connection electrode 44B (44A), is formed. The drain connection electrode 45A (45B) is connected to the drain electrode 41d which is positioned on a lower layer via the contact hole H3 formed in the interlayer insulating film 42C. In this manner, the connection electrodes 44A and 44B at least partially overlap with the selection transistors TR1 and TR2 in a planar view.

As described above, the drain connection electrodes 45A and 45B are patterned and formed on the same layer and at the same time as the connection electrodes 44A and 44B and are formed integrally with the corresponding connection electrode 44A or 44B (FIG. 17). The drain connection electrode 45A is formed integrally with the connection electrode 44A and the drain connection electrode 45B is formed integrally with the connection electrode 44B.

In the drain connection electrodes 45A and 45B, the interlayer insulating film 42A and the interlayer insulating film 42B are formed to cover the drain connection electrodes 45A and 45B, and on the interlayer insulating film 42B, the pixel electrodes 35A and 35B are formed. The drain connection electrodes 45A and 45B (the connection electrodes 44A and 44B) are connected to the pixel electrodes 35A and 35B via the contact holes H1 and H2 which are respectively formed in the interlayer insulating film 42A and 42B.

According to the configuration of the embodiment, it is possible to form the connection electrodes 44A and 44B (the drain connection electrodes 45A and 45B) and the pixel electrodes 35A and 35B in the vicinity of and in a region which overlaps in a planar view with the selection transistors TR1 and TR2. Since it is not possible to ignore the fraction of area taken up by the selection transistors in one pixel compared to the other regions, it is preferable to reduce the fraction as much as possible in order to improve the aperture ratio, but there are difficulties in manufacturing when the fraction is reduced to be equal to or less than a certain value. By adopting the configuration described above, it is possible for the pixel electrode 35 to be formed also on the selection transistors TR1 and TR2 and it is possible to expand the fraction of the region which contributes to display in one pixel.

In the previous embodiment, since there is the configuration where the respective drain electrodes 41d of the selection transistors TR1 and TR2 are formed on the same layer as the connection electrodes 44A and 44B, a degree of distance is provided in order to secure insulation of the drain electrodes 41d and the connection electrodes 44A and 44B, but in the embodiment, due to the interlayer insulating film 42C arranged between the respective drain electrodes 41d of the selection transistors TR1 and TR2 and the connection electrodes 44A and 44B, insulation of both is secured. As a result, it is possible to form the connection electrodes 44A and 44B in the vicinity of or so as to overlap in a planar view with the selection transistors TR1 and TR2.

In addition, according to the configuration of the embodiment, since the connection electrodes 44A and 44B are formed in a layer different to not only the drain electrode 41d but also the data line 68 (the source electrode 41c), it is possible to form the pixel electrode 35 on the data line 68. According to this, it is possible to further expand the area which contributes to display and a brighter high-precision display is possible.

### Manufacturing Method of Electrophoretic Display Device According to Second Embodiment

Next, the manufacturing method of the electrophoretic display device according to the second embodiment will be described.

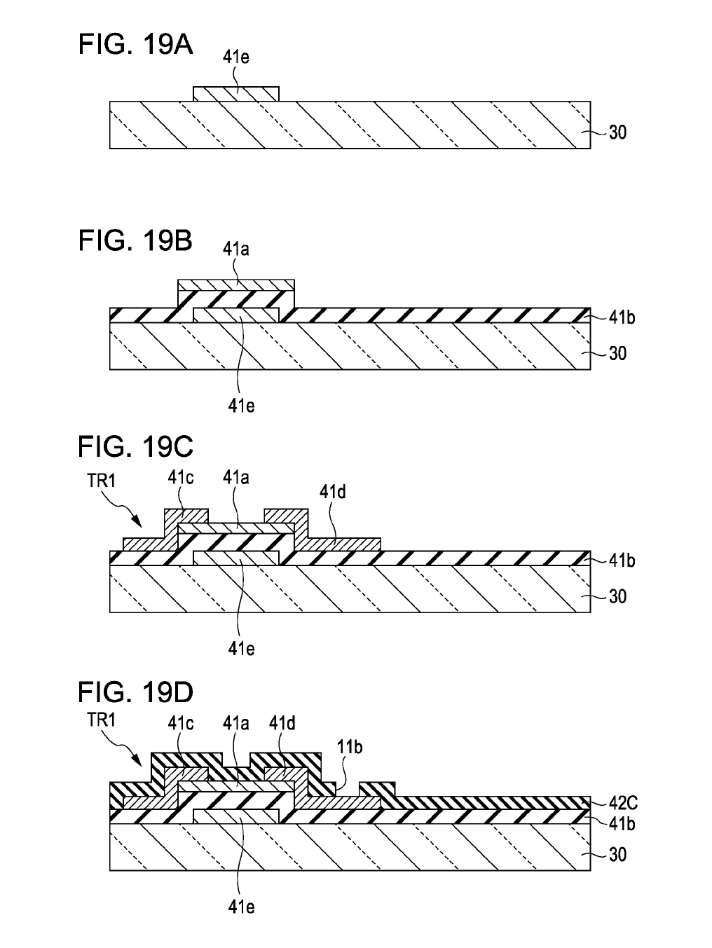

FIGS. 19A to 21B are partial cross-sectional diagrams for describing the manufacturing process of the electrophoretic display device.

In addition, the same description of the manufacturing method as the previous embodiment will not be included where appropriate.

First, as shown in FIG. 19A, 300 nm of aluminum (Al) is deposited using a sputtering method over the entire substrate surface on the first substrate 30 formed from a glass substrate with a thickness of 0.6 mm, and the gate electrode 41e is formed using a photo etching method.

Next, as shown in FIG. 19B, a silicon oxide film with a thickness of 300 nm is formed over the entire substrate surface using a plasma CVD method and the gate insulating film 41b is formed. After that, on the gate insulating film 41b, the semiconductor layer 41a with a thickness of 50 nm is formed from a-IGZO (an oxidation product of In, Ga, and Zn) using a sputtering method.

Next, as shown in FIG. 19C, 300 nm of Al is formed using a sputtering method, the source electrode 41c and the drain electrode 41d are formed and the first connection electrode 44A (not shown) and the second connection electrode 44B are formed by patterning using a photo etching method so as to partially sit on the semiconductor layer 41a.

Next, as shown in FIG. 19D, the interlayer insulating film 42C formed from a silicon nitride film with a thickness of 300 nm is formed using a plasma CVD method so as to cover the source electrode 41c and the drain electrode 41d. After that, a through hole 11b is formed which partially exposes the drain electrode 41d using a photo etching method.

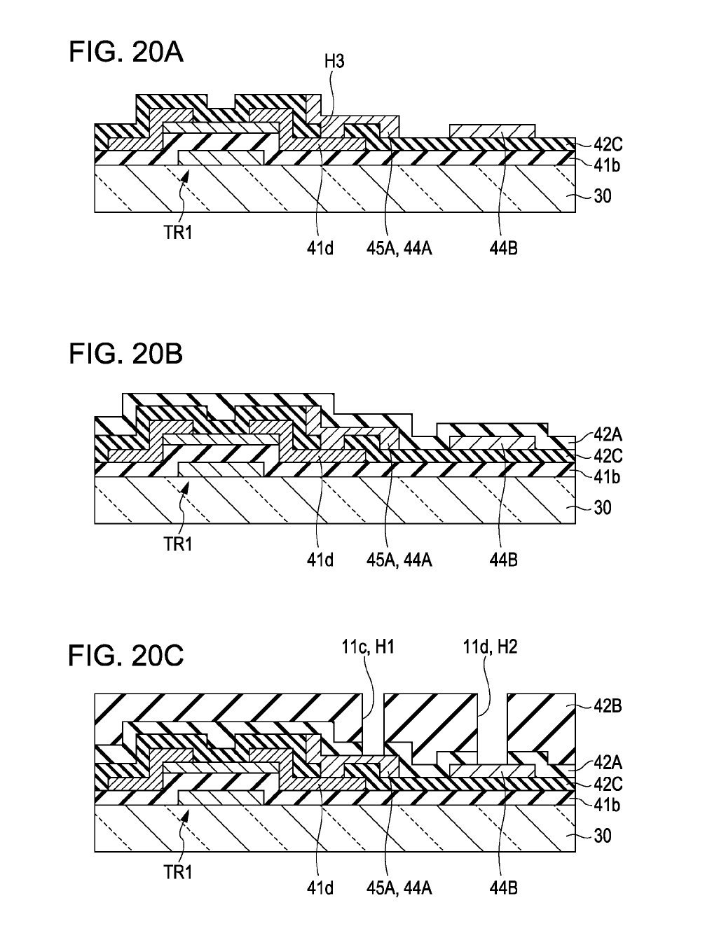

Next, as shown in FIG. 20A, the contact hole H3 is formed in the interlayer insulating film 42C using a photo etching method. After that, Al with a thickness of 300 nm is deposited on the interlayer insulating film 42C using a sputtering method, and the drain connection electrode 45A (45B) and the connection electrode 44A (44B) are patterned and formed at the same time using a photo etching method. The drain connection electrode 45A (45B) is connected to the drain electrode 41d via the contact hole H3.

Next, as shown in FIG. 20B, the interlayer insulating film 42A formed from a silicon oxide film with a thickness of 300 nm is formed using a plasma CVD method so as to cover the interlayer insulating film 42C and the drain connection electrodes 45A and 45B and the connection electrodes 44A and 44B provided on the interlayer insulating film 42C.

Next, as shown in FIG. 20C, by the interlayer insulating film 42B formed from photosensitive acrylic with a thickness of 1 μm on the interlayer insulating film 42A being applied, exposed, and developed, through holes are formed in the interlayer insulating film 42B until the interlayer insulating film 42A. After that, through holes are formed in the interlayer insulating film 42A using an etching method with the interlayer insulating film 42B as a mask, and a through hole 11c (the contact hole H1) and a through hole 11d (the contact hole H2) are formed.

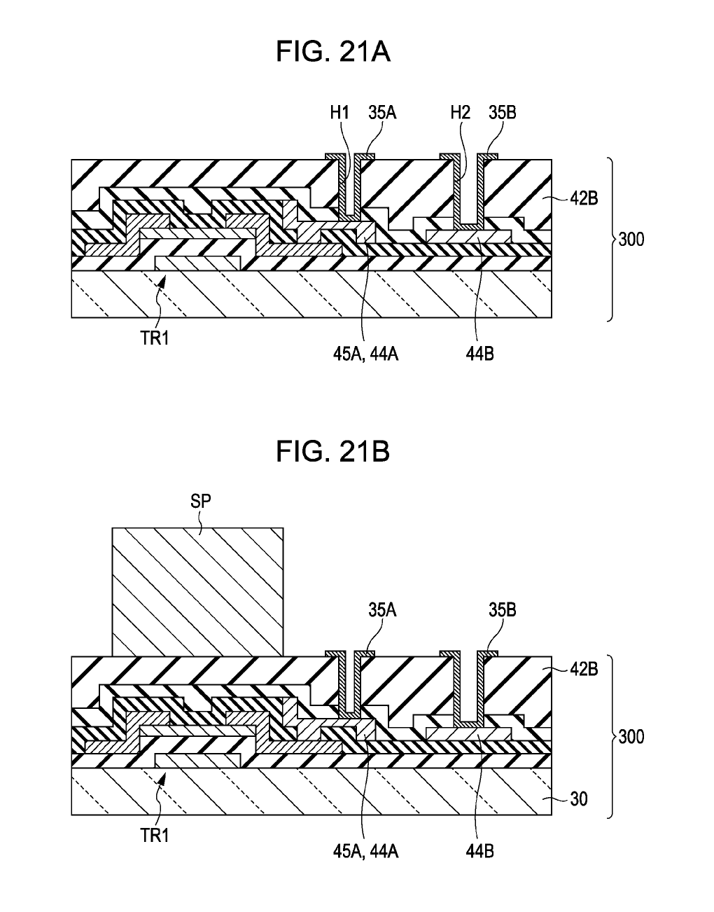

Next, as shown in FIG. 21A, an ITO film is formed on the entire surface of the interlayer insulating film 42B, and by performing patterning, the plurality of pixel electrodes 35A and 35B and the plurality of contact holes H1 and H2 are formed. The first pixel electrode 35A is connected to the connection electrode 44A via the contact hole H1 and the second pixel electrode 35B is connected to the connection electrode 44B via the contact hole H2.

Next, as shown in FIG. 21B, the spacer SP with a height of 50 μm is formed on the top surface of the element substrate 300 (interlayer insulating film 42B). Although not shown, next, after the electrophoretic material is applied on the element substrate 300, the opposing substrate 310 is joined onto the element substrate 300. In this manner, the electrophoretic display device according to the embodiment is completed.

According to the manufacturing method of the embodiment, since it is possible to pattern and form the drain connection electrodes 45A and 45B at the same time as the connection electrodes 44A and 44B, it is not necessary to separately receive a process of forming the drain connection electrodes 45A and 45B.

### Third Embodiment

Next, an electrophoretic display device according to a third embodiment will be described. Below, the parts which differ from the first embodiment will be described. The other parts are similar to the first embodiment.

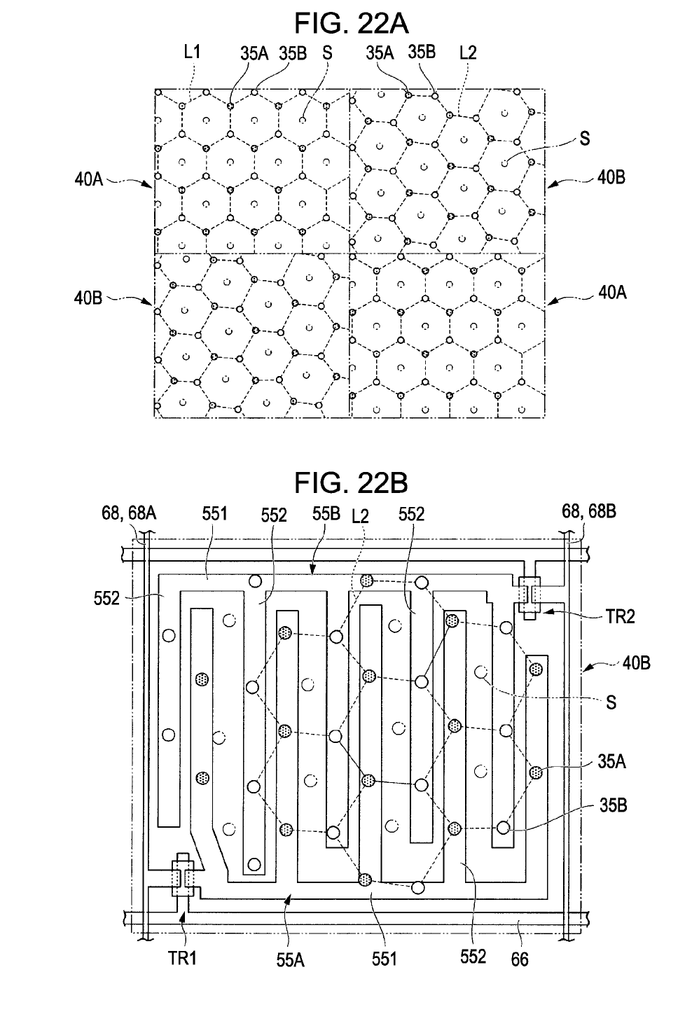

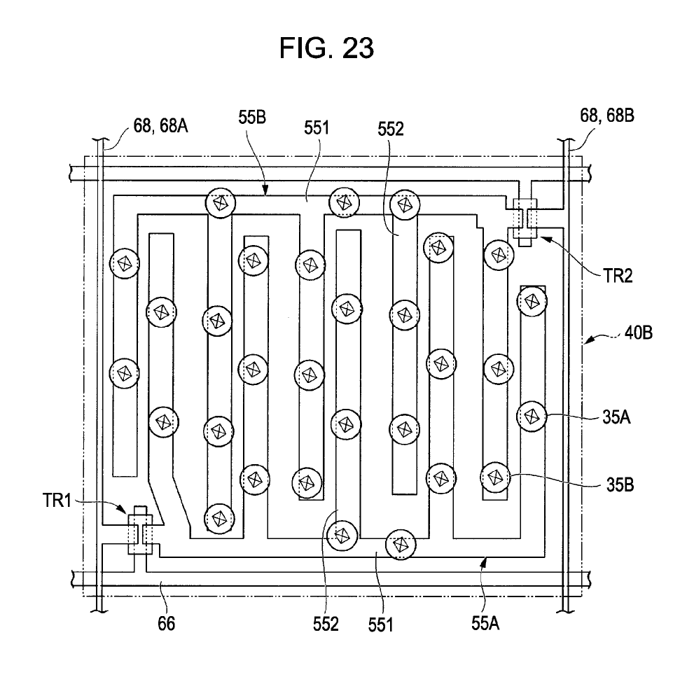

FIG. 22A is a planar diagram schematically illustrating a state of a pixel arrangement in a display region of an electrophoretic display device according to the third embodiment and FIG. 22B is a planar diagram illustrating a configuration of one pixel. FIG. 23 is a planar diagram illustrating a specific configuration example of one pixel.

As shown in FIG. 22A, in the electrophoretic display device according to the embodiment, the pixel 40A where the pixel electrodes 35A and 35B are arranged in the first layout L1 and the pixel 40B where the pixel electrodes 35A and 35B are arranged in a second layout L2 are mixed in a matrix formation in the display region. That is, in both the row direction and the column direction, the pixel 40A arranged in the first layout L1 and the pixel 40B arranged in the second layout L2 are alternately arranged. The first pixel described above and the second pixel described above are alternately arranged along the arrangement direction of the pixels.

On the other hand, as shown in FIG. 22B, the pixel 40B is provided with the plurality of pixel electrode 35A and 35B, the plurality of the no-electrode-formed regions S, connection electrodes 57A and 57B, and the selection transistors TR1 and TR2 in one pixel.

As shown in FIGS. 22B and 23, the plurality of pixel electrode 35A and 35B and the plurality of the no-electrode-formed regions S are each uniformly distributed in the pixel 40B. In the same manner as the first embodiment, there is a repeated pattern arranged in one direction. Also in this embodiment, there is three of each of the pixel electrodes 35A and 35B and each of the pixel electrodes 35A and 35B are arranged so that there is a hexagon. However, in the embodiment, the layout is the first layout L1 shown in the first embodiment before rotated at a predetermined angle centered around the no-electrode-formed region S positioned in the center. Specifically, the second layout L2 is the first layout L1 rotated by 30°. Here, the rotation angle is not limited to 30°.

The positioning of the no-electrode-formed region S at the center of the arrangement of the six pixel electrodes 35A and 35B arranged in a hexagonal shape is the same as the previous embodiment.

The connection electrodes 55A and 55B are configured to have a trunk portion 551 which extends in parallel to the scanning line 66 and a plurality of branch portions 552 which are parallel to the data line 68 and are arranged in a plurality of stripes, and the branch portions 552 become a pectinate shape connected by the trunk portion 551.

Each of the branch portions 552 of the first connection electrode 55A correspond to a plurality of first pixel electrode 35A and each of the branch portions 552 of the second connection electrode 55B correspond to a plurality of second pixel electrode 35B.

In the embodiment, the arrangement pattern of the pixel electrodes 35A and 35B differ for each pixel 40A and 40B in the display region. By the pixel 40A where the arrangement of the pixel electrodes 35A and 35B is the first layout L1 and the pixel 40B where the arrangement of the pixel electrodes 35A and 35B is the second layout L2 being arranged vertically and horizontally in a matrix formation, it is possible for the arrangement of the pixel electrodes 35A and 35B in the entire display region to be random. It is easy for streaks to be generated in the display when the pixel arrangement of all of the pixels 40A and 40B is uniform, and in some cases, moire interference bands are also generated. It is possible to resolves streaks and the like by the arrangement pattern of the pixel electrodes 35A and 35B in the pixels 40A and 40B being non-uniform, or more preferably, being a random arrangement. According to this, visual recognition is heightened and an excellent display is obtained.

In addition, the arrangement pattern of the plurality of pixel electrodes 35A and 35B may differ for adjacent pixels, but the arrangement pattern of each pixel electrode 35A and 35B may differ for each pixel.

In FIG. 22A, the layout L1 and the layout L2 are alternately lined up vertically and horizontally, but the layout L1 and the layout L2 may be randomly arranged. Furthermore, three or more layouts may be provided and randomness may be realized.

Below, modified examples of the embodiments described above and other embodiments will be described. The modified examples and other embodiments may be implemented by being mutually combined or can be implemented by being combined with any of the first to the third embodiments.

### Modified Example 1

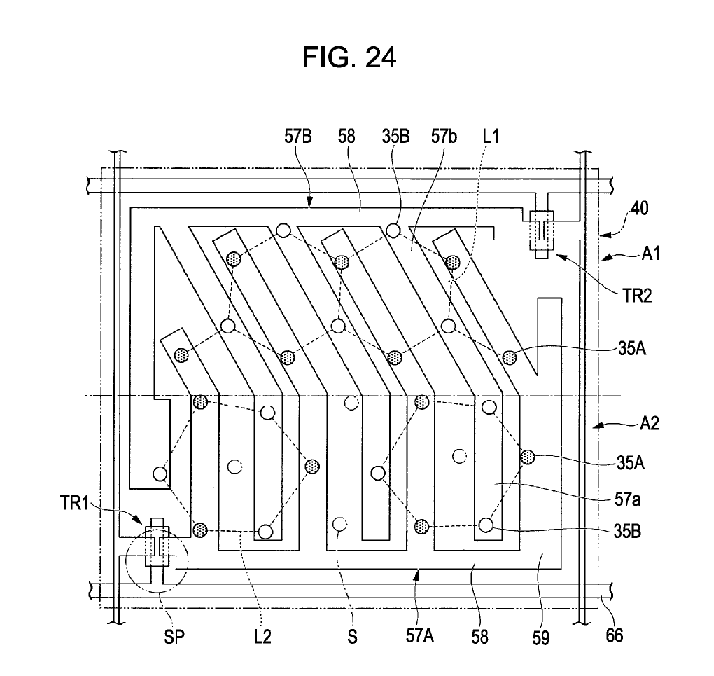

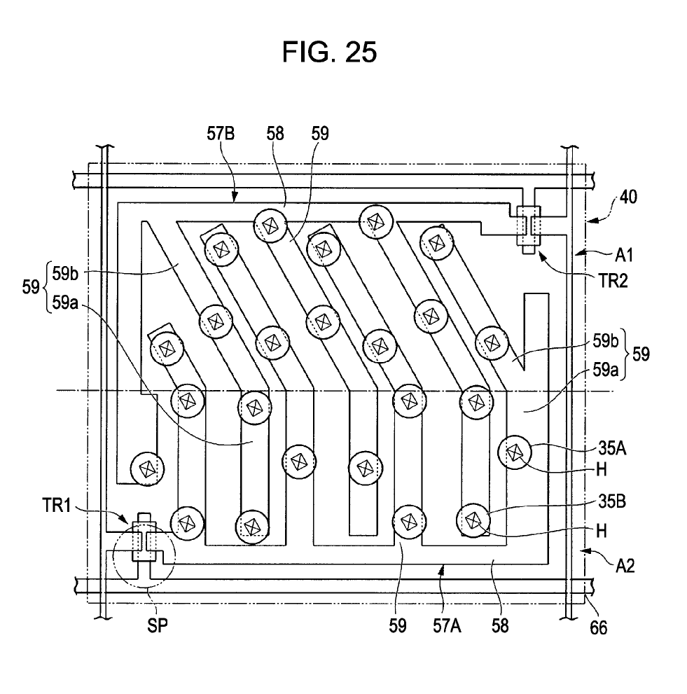

FIG. 24 is a planar diagram illustrating a simplification of a pixel configuration of a modified example 1, and FIG. 25 is a planar diagram illustrating a pixel configuration shown in FIG. 24 in detail.

As shown in FIG. 24, the one pixel 40 may have a pixel pattern region A1 where the pixel electrodes 35A and 35B are arranged in the first layout L1 and a pixel pattern region A2 where the pixel electrodes 35A and 35B are arranged in the second layout L2.

As shown in FIGS. 24 and 25, the pixel 40 is provided with the connection electrodes 57A and 57B which have a trunk portion 58 and a plurality of branch portions 59 which are connected by the trunk portion 58 and each are configured in a pectinate shape.

In a case where the pixel 40 is theoretically divided into two regions by a line segment parallel with the scanning line 66, the connection electrodes 57A and 57B are arranged in layouts which are different from each other in each of the two divided regions. Specifically, the branch portions 59 of the connection electrodes 57A and 57B are straight line portions 57a which extend in a vertical direction from the trunk portion 58 in the region on the connection electrode 57A side out of the two divided regions and are inclined portions 57b which are inclined at a predetermined angle with regard to the straight line portions 57a in the region on the connection electrode 57B side out of the two divided regions.

Here, the straight line portions 57a of each of the connection electrodes 57A and 57B are arranged parallel to each other and the inclined portions 57b of each of the connection electrodes 57A and 57B are arranged parallel to each other. In addition, the pixel electrodes 35A and 35B are arranged in the layout L2 in the region on the connection electrode 57A side out of the two divided regions and are arranged in the layout L1 in the region on the connection electrode 57B side out of the two divided regions.

In this manner, it is possible to further prevent the generation of display streaks and interference bands by making the arrangement of the pixel electrodes 35A and 35B in one pixel different for each of the regions A1 and A2. In addition, manufacturing is easy since the pattern for each pixel 40 is the same.

In addition, the pixel may be divided into three or more regions and the arrangement of the pixels electrodes in each may be different. In addition, the division may not only be in a data line direction but the division may also be in a gate line direction.

### Modified Example 2

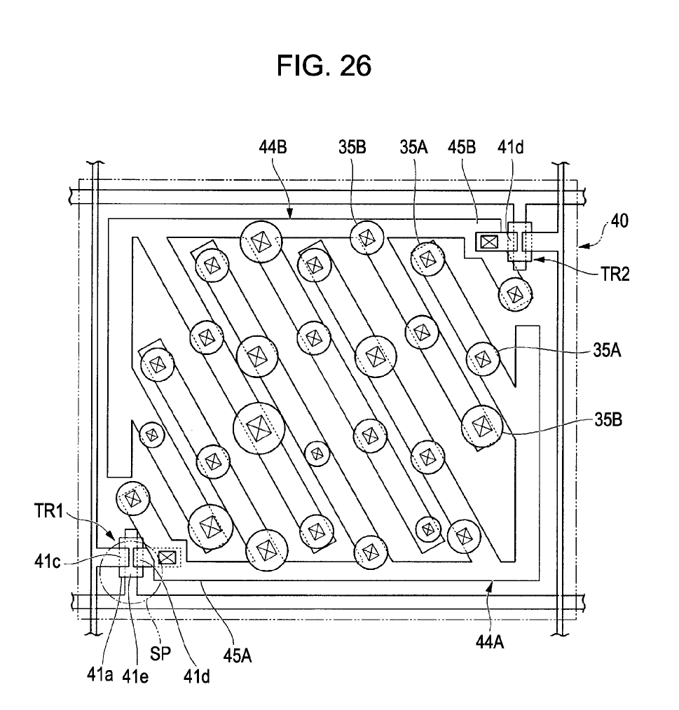

FIG. 26 is a planar diagram illustrating a pixel configuration of a modified example 2.

As shown in FIG. 26, in one pixel, the sizes of the first pixel electrodes 35A in a planar view are different and the sizes of the second pixel electrodes 35B in a planar view are different. By randomly arranging the pixel electrodes 35A and 35B which have different diameters in each pixel 40, an effect is obtained where the streaks generated when displaying are difficult to see since the direction (streaks) are difficult to determine.

In addition, the pixel electrodes 35A and 35B may each be formed in sizes of two or more types and the arrangement of each of the pixel electrodes 35A and 35B may be random.

By arranging the plurality of pixel electrodes 35A and 35B randomly in one pixel, it is possible to further increase the effect of eliminating the display streaks.

In addition, the random arrangement such as this uses two or more types, and as shown in FIG. 22A, may be a random arrangement which is different for different pixels 40.

### Modified Example 3

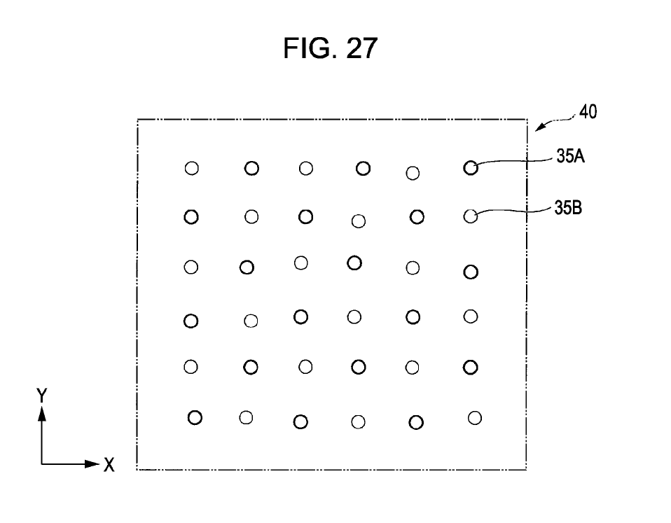

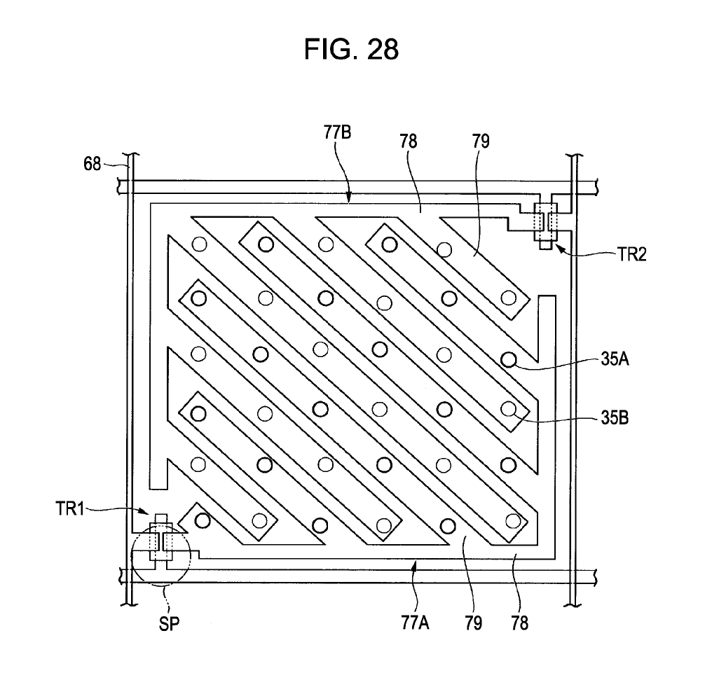

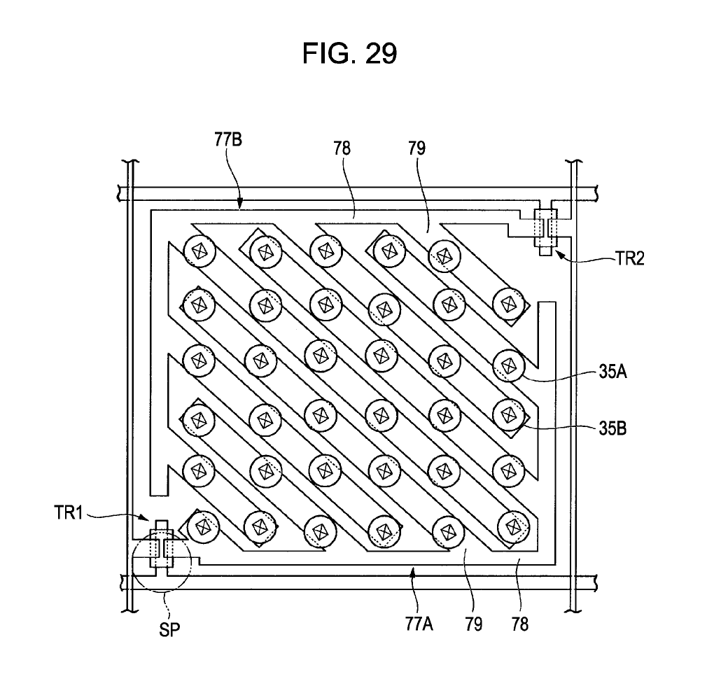

FIG. 27 is a planar diagram illustrating a layout of a pixel electrode in one pixel of a modified example 3, FIG. 28 is a planar diagram illustrating a simplification of a configuration in one pixel, and FIG. 29 is a planar diagram illustrating a configuration of one pixel in detail.

As shown in FIGS. 27 to 29, the first pixel electrodes 35A and the second pixel electrodes 35B are alternately arranged with uniform intervals between each other. The first pixel electrode 35A corresponds to negatively charged electrophoretic particles which have a negative charge and the second pixel electrode 35B corresponds to positively charged electrophoretic particles which have a positive charge. The no-electrode-formed region S is not provided.

The pitch of branch portions 79 of a connection electrode 77A which corresponds to the first pixel electrode 35A and branch portions of a connection electrode 77B which corresponds to the second pixel electrode 35B are constant relative to each other.

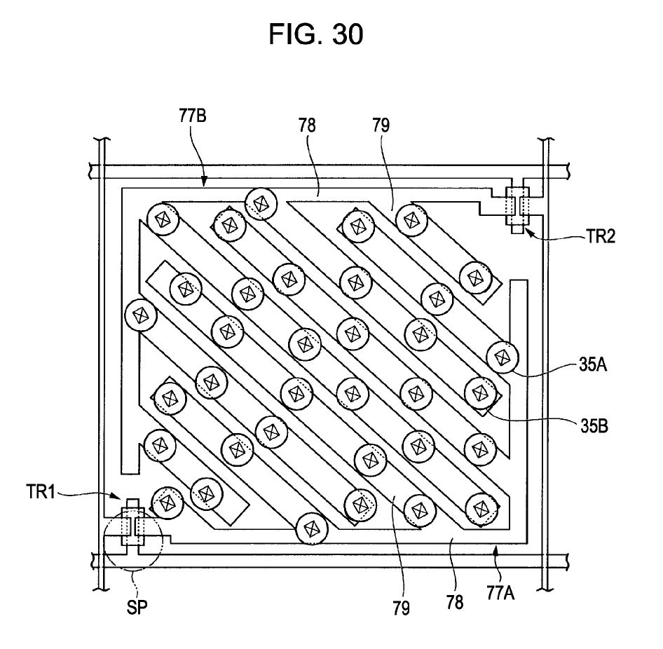

Alternatively, as shown in FIG. 30, the first pixel electrode 35A and the second pixel electrode 35B may be randomly arranged in the pixel. Even with the configuration such as this, it is possible to resolve the display streaks and interference bands.

As methods for eliminating display streaks, there are the above configuration examples, and the methods are shown where the size and positioning of the pixel electrodes, the layout of the pixel electrodes between pixels, and the layout of the pixel electrodes in the pixel are random, but these may be suitably combined.

### Other Embodiments

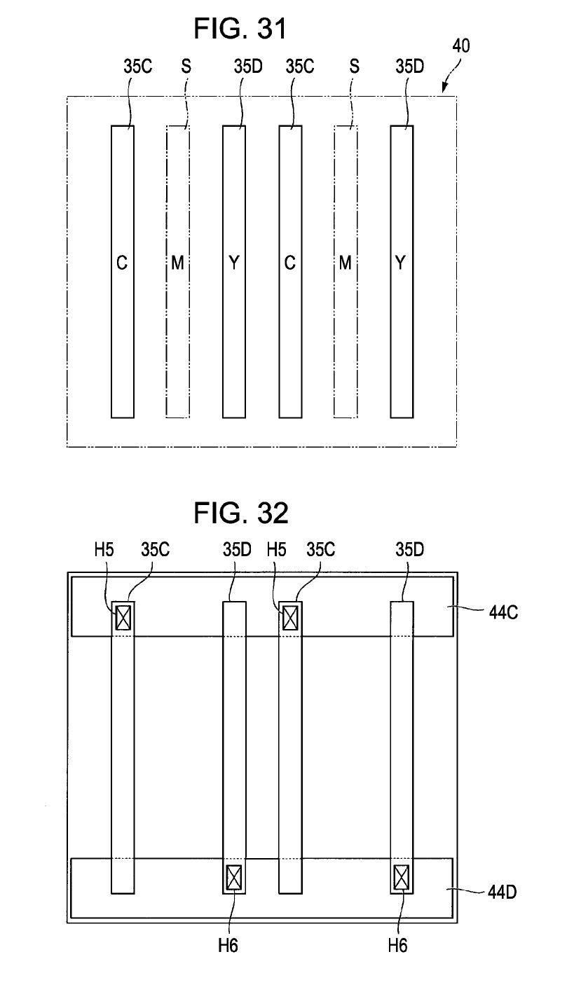

FIG. 31 is a planar diagram illustrating another configuration example of a pixel electrode.

As shown in FIG. 31, a plurality of pixel electrodes 35C (first electrodes) and pixel electrodes 35D (third electrodes) may be arranged with stripe shapes in one pixel 40. Each of the pixel electrodes 35C and 35D have a planar rectangular shape and each of the pixel electrodes 35C and 35D are lined up with each other in an extending direction and arranged in predetermined intervals in a short-side direction. The lengths of the short sides of each of the pixel electrodes 35C and 35D are set to a dimension smaller than the cell gap. For example, it is most preferable if the length of the short side is a length equal to or less than ½ of the cell gap.

The no-electrode-formed region S is provided between the first pixel electrode 35C which corresponds to the negatively charged particles 26 (C) which have a negative charge and the second pixel electrode 35D which corresponds to the positively charged particles 27 (Y) which have a positive charge. In the no-electrode-formed region S, there is actually no electrode formed and a spacer is provided. As the arrangement order of the first pixel electrode 35C, the second pixel electrode 35D, and the no-electrode-formed region S, the first pixel electrode 35C, the no-electrode-formed region S, and the second pixel electrode 35D are arranged in this order in a repeated pattern in one direction.

Since the pixel electrodes 35C and 35D of the embodiment have a wider area than the circular pixel electrodes described in the previous embodiment, it is possible to efficiently adsorb the particles.

FIG. 32 is a planar diagram illustrating a configuration of one pixel shown in FIG. 31 in detail.

As shown in FIG. 32, two connection electrodes 44C and 44D are formed which extend along an arrangement direction of the pixel electrodes 35C and 35D on the element substrate. In the first connection electrode 44C, the first pixel electrode 35C is connected via a contact hole H5, and in the second connection electrode 44D, the second pixel electrode 35D is connected via a contact hole H6.

Next, other applied examples of the electrophoretic display device will be described.

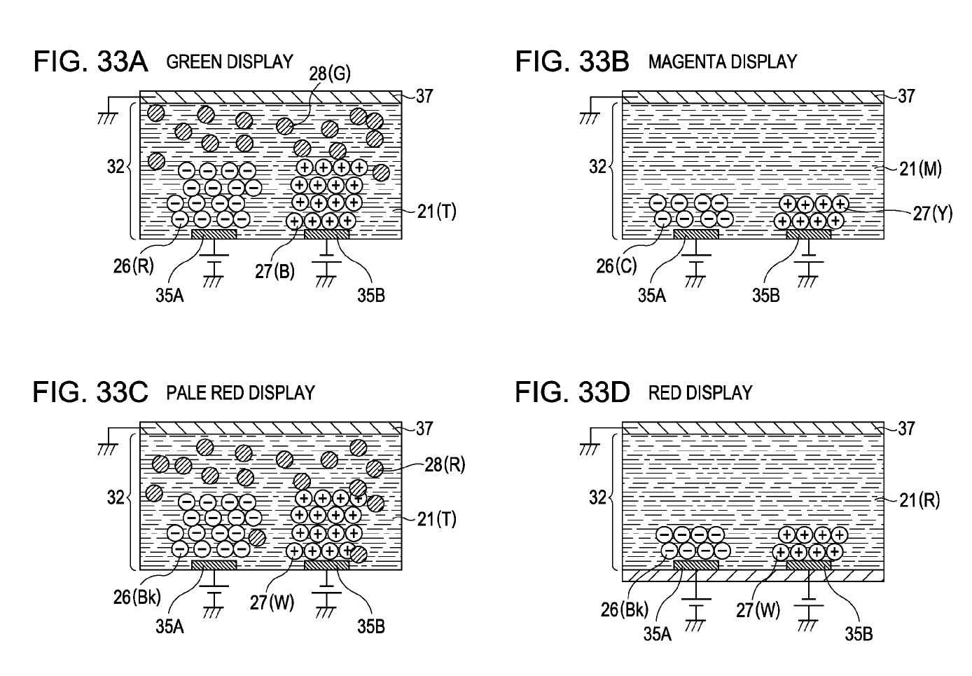

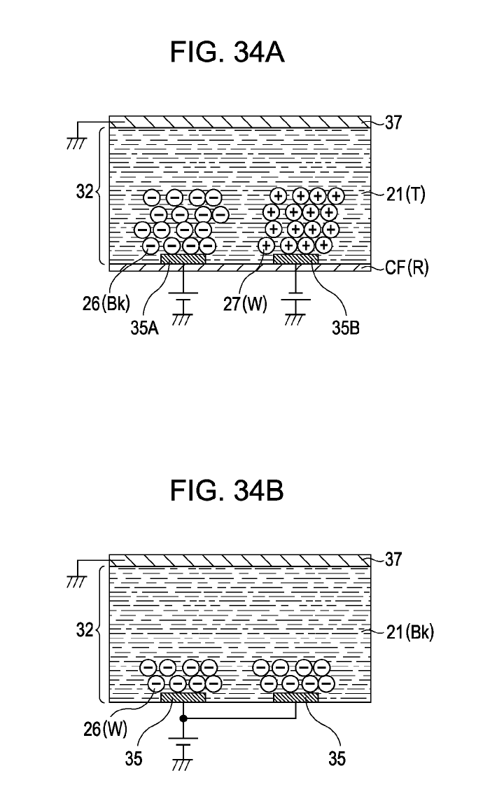

FIGS. 33A to 34B are cross-sectional diagrams illustrating schematic configurations of other applied examples.

In FIG. 33A, negatively charged particles 26 (R) with a red color which have a negative charge, positively charged particles 27 (B) with a blue color which have a positive charge, and non-charged particles 28 (G) with a green color are held in the colorless and transparent dispersion medium 21 (T). In this case, it is possible to display green by applying a positive voltage to the first pixel electrode 35A and applying a negative voltage to the second pixel electrode 35B. It is also possible to mutually change the colors of each of the particles.

In FIG. 33B, the negatively charged particles 26 (C) with a cyan color and the positively charged particles 27 (Y) with a yellow color are held in a dispersion medium 21 (M) with a magenta color. In this case, it is possible to display magenta by applying a positive voltage to the first pixel electrode 35A and applying a negative voltage to the second pixel electrode 35B. It is also possible to mutually change the colors of the positively charged particles, the negatively charged particles, and the dispersion medium. In addition, the three colors of RGB may be used instead of the three colors of CMY.

In FIG. 33C, negatively charged particles 26 (Bk) with a black color, positively charged particles 27 (W) with a white color, and non-charged particles 28 (R) with a red color are held in the transparent dispersion medium 21 (T). In this case, it is possible to display red due to the non-charged particles 28 (R) with a red color by applying a positive voltage to the first pixel electrode 35A and applying a negative voltage to the second pixel electrode 35B. In addition, it is possible to adjust the brightness and saturation of red by controlling the distribution of each of the white and black particles on the opposing electrode 37 side. By arranging pixels which have blue and green non-charged particles instead of red, it is possible to perform a color display.

In addition, CMY and the like may be used as the colors of the non-charged particles.

In FIG. 33D, the negatively charged particles 26 (Bk) with a black color and the positively charged particles 27 (W) with a white color are held in a dispersion medium 21 (R) with a red color. In this case, it is possible to display red due to the dispersion medium 21 (R) with a red color by applying a positive voltage to the first pixel electrode 35A and applying a negative voltage to the second pixel electrode 35B. In addition, it is possible to adjust the brightness and saturation of red by controlling the distribution of each of the white and black particles on the opposing electrode 37 side. By arranging pixels which have blue and green dispersion mediums instead of red, it is possible to perform a color display.

In addition, CMY and the like may be used as the colors of the dispersion medium.

FIG. 34A shows a two-particle system configuration and FIG. 34B shows a one-particle system configuration.

In FIG. 34A, the negatively charged particles 26 (Bk) with a black color and the positively charged particles 27 (W) with a white color are held in the colorless and transparent dispersion medium 21 (T). In addition, here, a color filter CF (R) with a red color is provided in a lower layer of the pixel electrode 35A and 35B. In this case, it is possible to display red by applying a positive voltage to the first pixel electrode 35A and applying a negative voltage to the second pixel electrode 35B.

In addition, in the configuration of FIG. 34A, the configuration may have no color filter CF (R). In this case, it is possible to display white and black using the negatively charged particles 26 (Bk) with a black color and the positively charged particles 27 (W) with a white color.

In FIG. 34B, only negatively charged particles 26 (W) with a white color are held in a dispersion medium 21 (Bk) with a black color. The plurality of pixel electrodes 35 are formed on the element substrate and are mutually connected in the lower layer. In this case, since the negatively charged particles 26 (W) with a white color move to the pixel electrode 35 side due to a positive voltage being applied to each of the pixel electrodes 35 all together, it is possible to display black by the dispersion medium 21 (Bk) with a black color being visually recognized.

In addition, the dispersion medium may be white and the charged particles may be black.

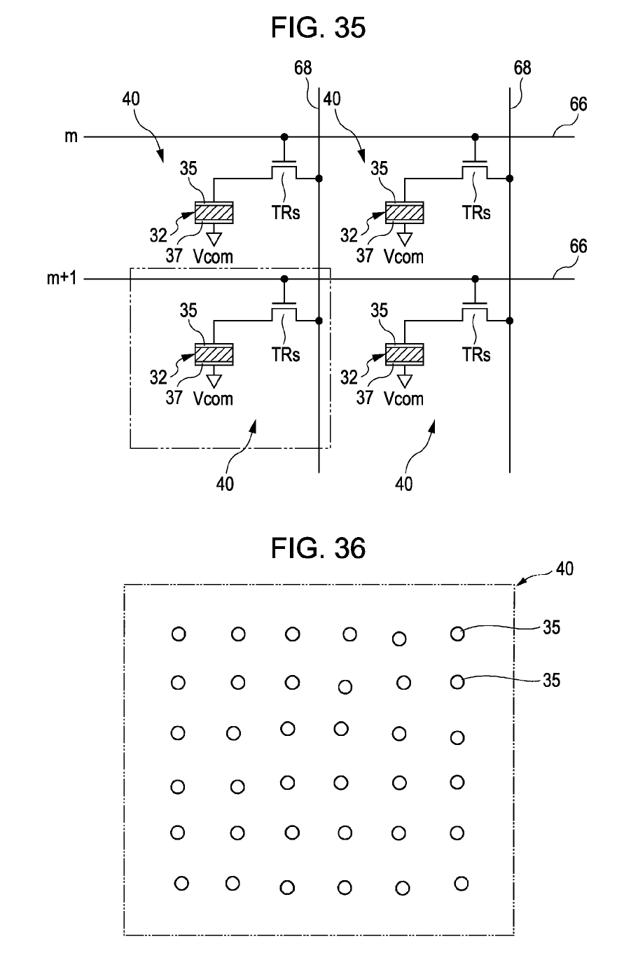

Next, a one-particle system configuration will be described using FIGS. 35 to 38.

FIG. 35 is an equivalent circuit diagram of a one-particle system.

As shown in FIG. 35, a selection transistor TRs and the electrophoretic layer 32 are provided in each of the pixels 40. In addition, while not shown in the diagram, there may be a configuration where a holding capacitance connected to the pixel electrode 35 is added.

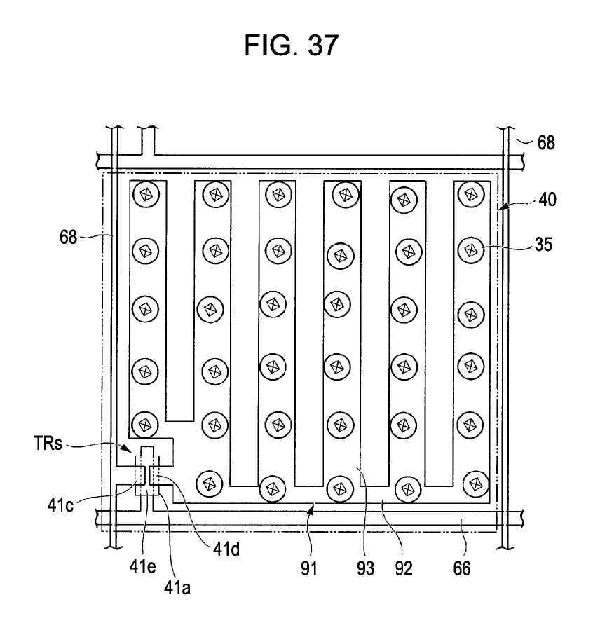

As shown in FIG. 36, the plurality of pixel electrodes 35 are arranged in rows in the pixel 40. The plurality of pixel electrodes 35 are arranged relative to each other with uniform intervals and are mutually connected by a connection electrode 91 formed in a lower layer side as shown in FIG. 37. The connection electrode 91 have a pectinate shape due to a trunk portion 92 which is parallel to the scanning line 66 and a plurality of branch portions 93 which are connected by the trunk portion 92 and are parallel to the data line 68. The connection electrode 91 such as this is patterned and formed at the same time and formed integrally with a drain electrode 41 of the selection transistor TRs provided in the pixel.

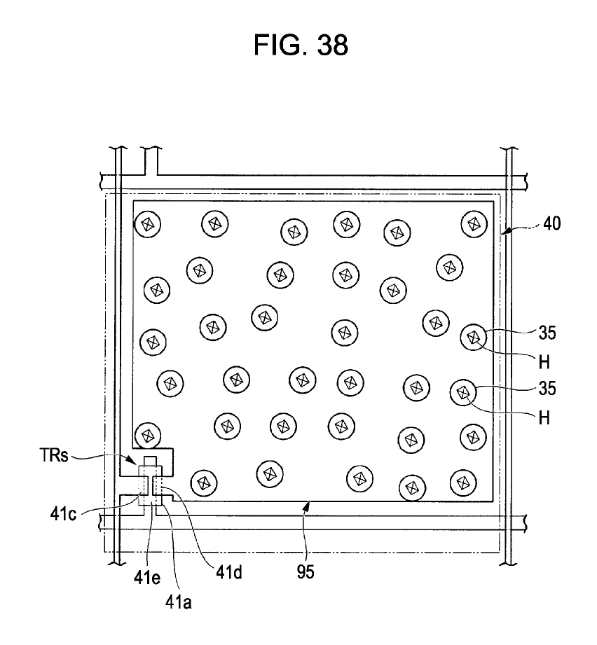

In addition, a connection electrode 95 may be provided which is formed without gaps over substantially the entire pixel region as shown in FIG. 38. Due to the formation such as this, since it is not necessary to match the positioning of the lower layer side of the connection electrode 95 even if the plurality of pixel electrodes 35 are arranged randomly, it is advantageous in terms of manufacturing.

In addition, in a case where a holding capacitance line is used, since a holding capacitance is formed between the connection electrode 95 and the holding capacitance line, it is possible for a large holding capacitance to be formed.

Above, preferred embodiments according to the invention have been described while referring to the attached diagrams, but it goes without saying that the invention is not particularly limited by the examples. It should be understood by those skilled in the art that various modifications and alterations can be made which are within the scope of the technical concept described in the claims and these belong to the technical scope of the invention.

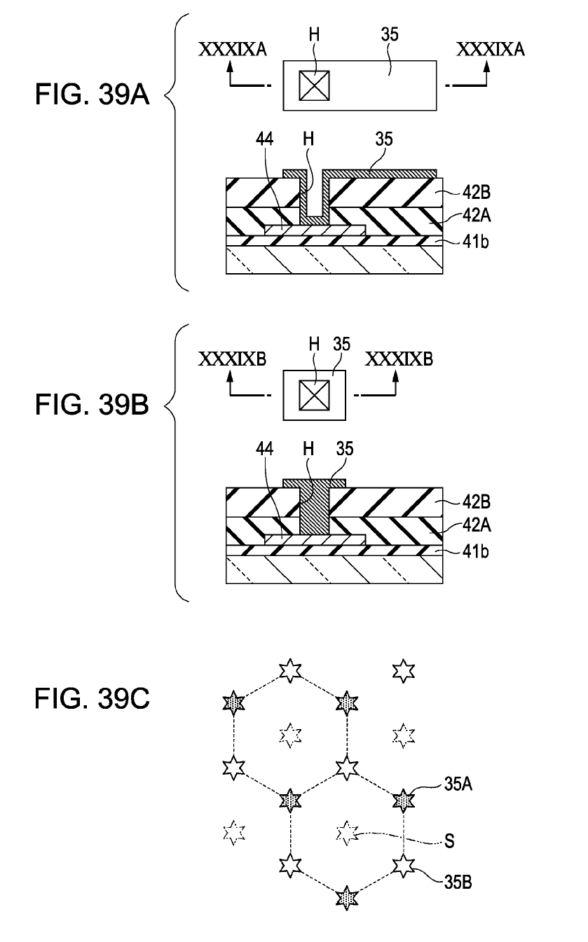

For example, in the previous embodiment, each of the pixel electrodes 35 have a planar circular shape but may have a rectangular shape as shown in FIG. 39A or a square shape as shown in FIG. 39B, and it is possible to adopt other shapes as long as each of the pixel electrodes 35 are reliably connected to the connection electrode 44 on the lower layer side via the contact hole H. Alternatively, as shown in FIG. 39C, the pixel electrodes 35A and 35B are substantially star shapes in a planar view. By making the pixel electrodes a shape where there are partial protrusions toward the adjacent pixel electrodes 35, an effect is obtained in that it is easier for an electric field to head toward the adjacent pixel electrode side and it is easier to generate color mixing. Here, since the arrangement of the pixel electrodes 35A and 35B is an arrangement which forms a hexagon in a planar view, the pixel electrode is a shape which has six protrusion portions. In a case where the arrangement of the pixel electrodes is an arrangement which forms a triangle in a planar view, the same effect is obtained by the pixel electrode being a shape which has three protrusion portions. In this manner, as the shape of the electrodes, various shapes can be applied.

In addition, as shown in FIG. 39B, there is a shape where the contact hole H is filled in using the pixel electrode 35 and there may be a configuration where the particles are prevented in advance from entering inside the contact hole.

In addition, also with the configurations in FIGS. 22A to 25 and FIGS. 28 to 30, there may be a configuration where a drain connection electrode is provided.

In addition, the plurality of both the first pixel electrodes 35A and second pixel electrodes 35B may not be provided for one pixel, and it is sufficient if at least two or more of the pixel electrodes 35 are provided in the pixel as shown in FIGS. 37 and 38 and the number thereof can be any number. At this time, the pixel electrodes 35 on the element substrate 30 may be arranged in uniform intervals or may be arranged randomly. In addition, the size of each of the pixel electrodes 35 is set so the total area of the pixel electrodes arranged in one pixel is equal to or less than ¼ of the pixel.

In addition, it is possible to have a one-particle system or a two-particle system configuration with one selection transistor.

In addition, in each of the embodiments, a liquid dispersion medium is used but the dispersion medium may be a gas.

### Electronic Apparatus

Next, cases will be described where the electrophoretic display devices of each of the embodiments described above are applied to electronic apparatuses.

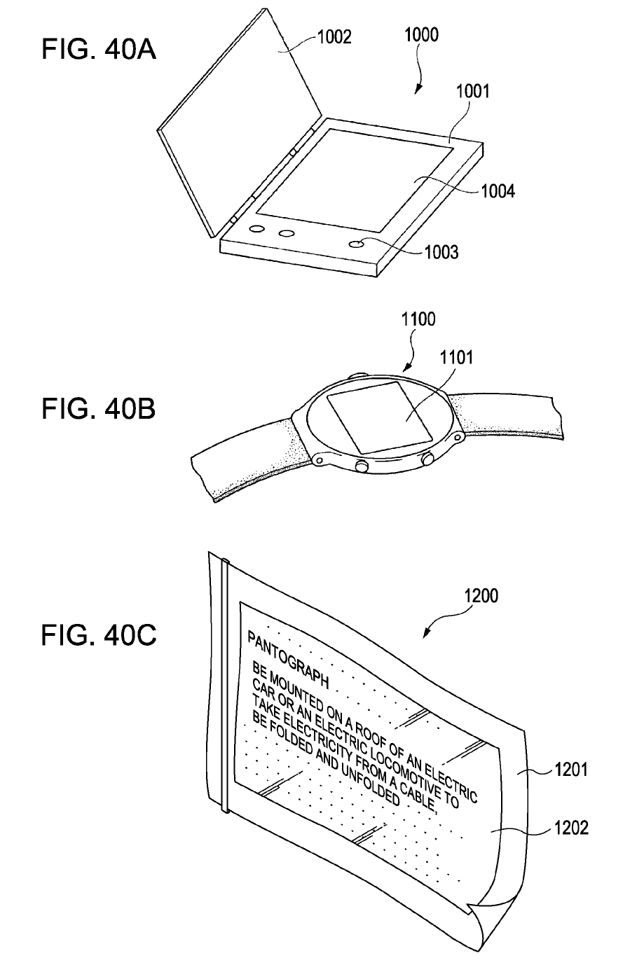

FIGS. 40A to 40C are perspective diagrams describing specific examples of electronic apparatuses where the electrophoretic display device of the invention has been applied.

FIG. 40A is a perspective diagram illustrating an electronic book which is an example of the electronic apparatus. An electronic book 1000 is provided with a frame 1001 with a book shape, a cover 1002 (able to be opened and closed) provided to freely rotate with regard to the frame 1001, an operation section 1003, and a display section 1004 configured using the electrophoretic display device of the invention.

FIG. 40B is a perspective diagram illustrating a wrist watch which is an example of the electronic apparatus. A wrist watch 1100 is provided with a display section 1101 configured using the electrophoretic display device of the invention.

FIG. 40C is a perspective diagram illustrating an electronic paper which is an example of the electronic apparatus. An electronic paper 1200 is provided with a body section 1201 configured using a rewriteable sheet having the same feeling and flexibility as paper and a display section 1202 configured using the electrophoretic display device of the invention.

For example, since it is supposed that a purpose of the electronic book and the electronic paper and the like is to have characters repeatedly written onto a white background, it is necessary to resolve residual images when erasing and residual images over time.

In addition, the range of electronic apparatuses to which the electrophoretic display device of the invention can be applied is not limited to these and broadly includes apparatuses which use a visual change in color tone which accompanies movement of charged particles.

According to the electronic book 1000, the wrist watch 1100 and the electronic paper 1200 above, since the electrophoretic display device according to the invention is adopted, an electronic apparatus is provided with a color display means.

In addition, the electronic apparatuses described above exemplify the electronic apparatuses according to the invention and do not limit the technical scope of the invention. For example, it is possible to appropriately use the electrophoretic display device according to the invention also in the display sections of electronic apparatuses such as a mobile phone or a portable audio device.

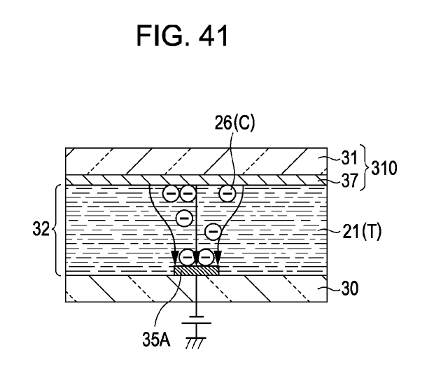

FIG. 41 is a diagram illustrating the distribution state of the charged particles when a voltage is applied.

In the left side of the diagram of FIG. 2 described above, the state is shown where a portion of the negatively charged particles 26 (C) which were adsorbed on the pixel electrode 35A have moved from the pixel electrode 35A toward the opposing electrode 37. At this time, the majority of the moved particles has reached the opposing electrode 37 and is positioned in the vicinity thereof. However, in practice, there are some charged particles 26 (C) which are positioned in the dispersion medium 21 (T) between the pixel electrode 35A and the opposing electrode 37 which have separated from the pixel electrode 35A without reaching the opposing electrode 37. Even in this case, gradation and mixed colors are expressed by the effective distribution area of the particles viewed from the opposing electrode 37 side which includes the negatively charged particles 26 (C) with a cyan color in the transparent dispersion medium 21 (T).

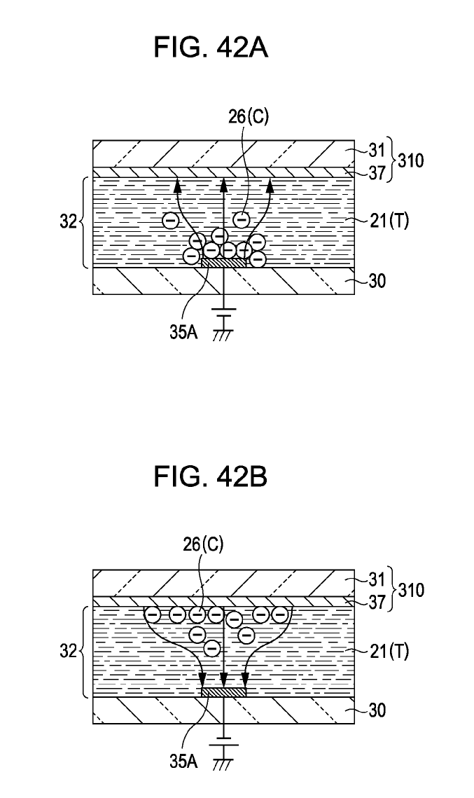

FIGS. 42A and 42B are diagrams illustrating the distribution state of the charged particles when a voltage is applied, where FIG. 42A is the appearance when a negative voltage is applied and FIG. 42B is the appearance when a positive voltage is applied.

In FIG. 3A described above, substantially all of the negatively charged particles 26 (C) are positioned in the vicinity of the pixel electrode 35A when the positive voltage VH is applied to the pixel electrode 35A and substantially all of the negatively charged particles 26 (C) are positioned in the vicinity of the opposing electrode 37 when the negative voltage VL is applied to the pixel electrode 35A, but to have the distribution states such as these, it is necessary to continually apply a voltage for a certain longer length of time or continually apply a large voltage.

In a case where the time of applying a voltage to the pixel electrode 35A is short, as shown in FIG. 42A, all of the charged particles 26 (C) are not moved to the pixel electrode 35A side and a portion of the charged particles 26 (C) are positioned in the dispersion medium 21 (T). In addition, as shown in FIG. 42B, in a case where the time of applying the negative voltage VL to the pixel electrode 35A is short, all of the charged particles 26 (C) are not moved to the opposing electrode 37 side and a portion of the charged particles 26 (C) are positioned in the dispersion medium 21 (T).

Even in this case, gradation and mixed colors are expressed by the effective distribution area of the particles viewed from the opposing electrode 37 side which includes the charged particles 26 (C) in the dispersion medium 21 (T).

As above, even if a portion of the charged particles 26 (C) are positioned in the dispersion medium 21 (T), operation of the electrophoretic display device is possible.

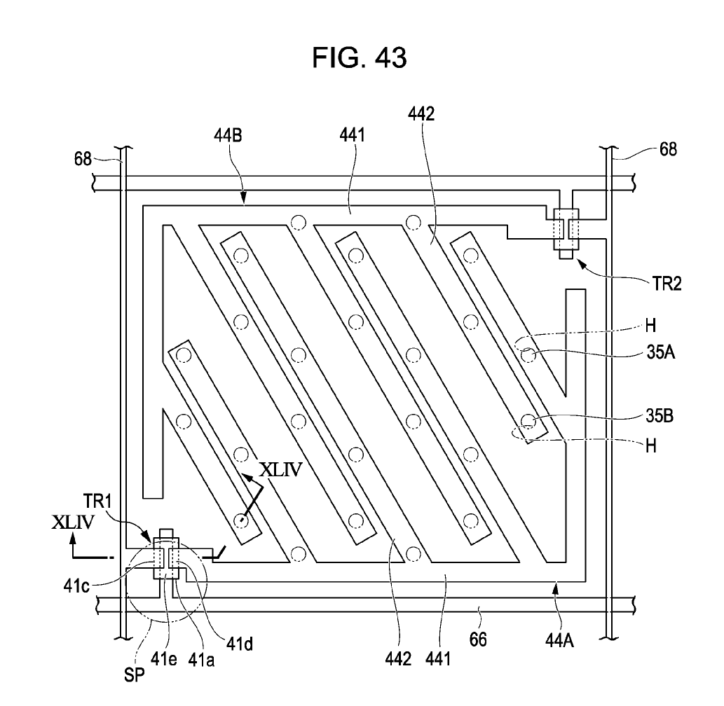

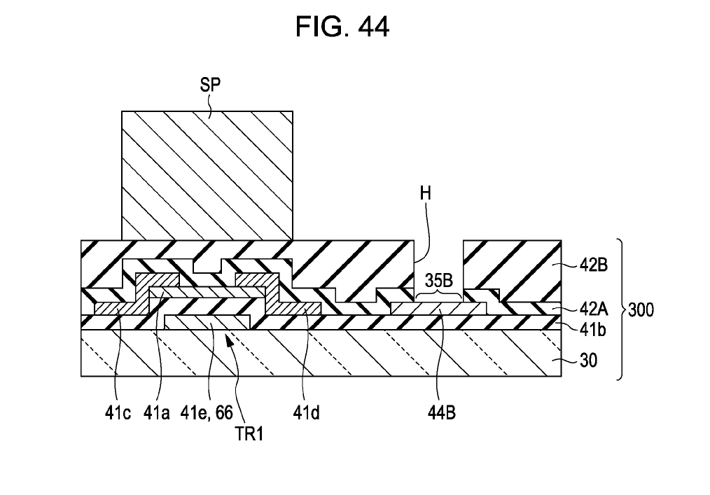

FIG. 43 is a planar diagram illustrating a modified example of a layout of one pixel (modified example of the configuration shown in FIGS. 10 and 11), and FIG. 44 is a cross-sectional diagram along a line XXXXIV-XXXXIV of FIG. 43.

As shown in FIG. 43, here, there is a configuration where the pixel electrode is not separately formed, and otherwise, is the same as the previous embodiment.

In the embodiment, the electrophoretic layer 32 is interposed between the element substrate 300 which includes from the first substrate 30 to the interlayer insulating film 42B (excluding the pixel electrode) and the opposing electrode 310 which includes from the second substrate 31 and the opposing electrode 37, and a portion of the connection electrode 44 formed on the first substrate 30 is a connection portion 44a with an external circuit.

In the interlayer insulating films 42A and 42B which are laminated on the connection electrode 44A (44B), the plurality of holes H are formed for partially exposing the connection electrode 44A (44B). Specifically, as shown in FIGS. 43 and 44, the plurality of holes H is formed at constant intervals following the pectinate shape of the connection electrode 44A (44B) so as to overlap with the connection electrode 44A (44B), and via the respective holes H, the connection electrode 44A (44B) is partially exposed. A portion of the connection electrode 44A (44B) which is exposed in the plurality of holes H functions as the pixel electrodes 35A and 35B with island shapes which are provided in the previous embodiment and comes in contact with the electrophoretic layer 32. Even with the configuration such as this, the operation as the electrophoretic display device is the same as the embodiment described above.

For example, when the positive voltage VH is applied to the connection electrode 44B, the negatively charged particles 26 (C) are drawn to the connection electrode 44B side which is exposed in the hole H and enter into the hole H. As a result, even in a case where the applying of the voltage to the connection electrode 44 is stopped, since many of the negatively charged particles 26 (C) are held in the hole H, it is possible to prevent the spreading out of the particles when having moved to a state where a voltage is not applied.

In addition, in the case where the pixel electrode 35 is not provided in a separate layer as shown in FIGS. 43 and 44, it is preferable in terms of reliability that the material of the surface of the connection electrode 44 at least in the hole H is the same material as the opposing electrode 37.

Here, it is sufficient if the connection electrodes 44A and 44B are not necessarily exposed from the insulating film. For example, in FIG. 44, there is the configuration where the hole is formed in the interlayer insulating films 42A and 42B, and penetrates therethrough and the connection electrode 44 is exposed, but there may be a configuration where the hole penetrates through only the interlayer insulating film 42B and the interlayer insulating film 42A remains. Even with this configuration, in a portion where the interlayer insulating film 42B has been removed, the fall in voltage at the interlayer insulating film 42B is lower than the other region where the interlayer insulating film 42B exists, and it is possible to more efficiently apply a voltage to the electro-optic material. As a result, a portion of the connection electrodes 44A and 44B which are positioned directly under the hole formed in only the interlayer insulating film 42B functions in practice as the pixel electrodes 35A and 35B.

In the embodiment and modified example described above, the connection electrode is formed as a thin wire and is not an electrode which covers the pixel area with no gaps. In the case of the electrode with no gaps, a slight voltage is applied to the electro-optic material via the interlayer insulating film even in a region other than the pixel area. This works in a direction of hindering the operation of the electrophoretic display device of the invention.

For example, when the charged particles are collected on the pixel electrodes 35A and 35B, a portion of the charged particles remains on the connection electrode which exists in the vicinity of the pixel electrodes 35A and 35B and are difficult to collect. In order to reduce the phenomena such as this, it is preferable if there is a configuration where the potential of the connection electrodes 44A and 44B is not applied to the electro-optic material. To achieve this, it is preferable if there is high resistance by the connection electrodes 44A and 44B being formed as a thin wire or the film thickness of the interlayer insulating films 42A and 42B on the connection electrodes 44A and 44B being thickened.

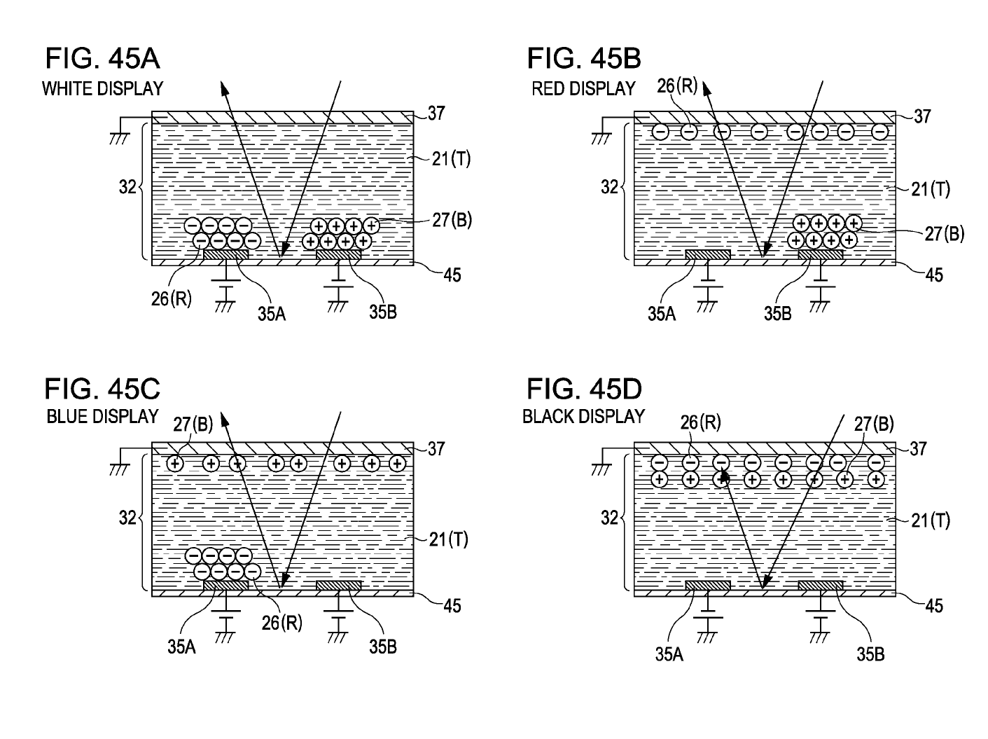

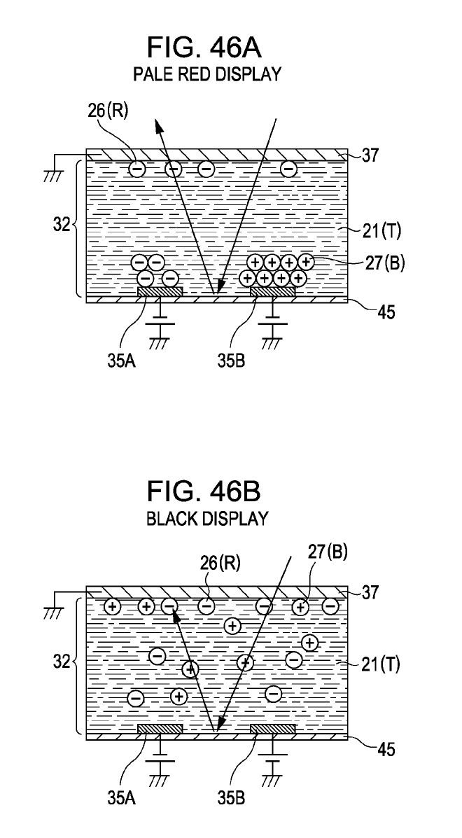

FIGS. 45A to 46B are diagrams illustrating the distribution state of the charged particles in a configuration example of another electrophoretic display device.

The electrophoretic display device shown in FIGS. 45A to 46B is provided with a reflective electrode 45 which is formed on the substrate surface on a lower layer side of the two types of the pixel electrodes 35A and 35B which are driven independently of each other in one pixel.

In the configuration of the electrophoretic display device shown in FIG. 2 described above, color display is performed by the scattering of the charged particles 26 (C) in the dispersion medium 21 (T). In this example, there is a configuration where display is performed also using the reflection of the reflective electrode 45.

The electrophoretic display device shown in FIGS. 45A to 46B has the configuration where the electrophoretic layer 32 is provided where two colors of the negatively charged particles 26 (R) and the positively charged particles 27 (B) which are formed from transparent particles are held in the transparent dispersion medium 21 (T).

In FIG. 45A, a state is shown where the positive voltage VH is applied to the pixel electrode 35A, the negative voltage VL is applied to the pixel electrode 35B, the negatively charged particles 26 (R) are collected on the pixel electrode 35A and the positively charged particles 27 (B) are collected on the pixel electrode 35B. At this time, external light which is incident from the opposing electrode 37 side is reflected by the reflective electrode 45 and exits to the outside. As a result, a white display is obtained. The operation of performing a white display may be a preset operation performed when changing an image.

In FIG. 45B, a state is shown where, after the execution of the preset operation where the white display shown in FIG. 45A is performed, the negatively charged particles 26 (R) with a red color are moved to the opposing substrate 310 side by applying the negative voltage VL to the pixel electrode 35A (and the pixel electrode 35B). At this time, since the red particles are transparent, after passing through the red particles, the incident light from the outside is reflected by the reflective electrode 45, passes through the red particles again, and exits to the front. The red particles have transmittance characteristics shown in FIG. 45B and absorb light other than red. As a result, there is a red display.

In FIG. 45C, a state is shown where, after the execution of the preset operation described above, the positively charged particles 27 (B) which have collected on the pixel electrode 35B during the preset operation are moved to the opposing substrate 310 side by applying a positive voltage to the pixel electrode 35B (and the pixel electrode 35A). At this time, light other than blue is absorbed in the blue particles. Then, since the blue light which passing through the positively charged particles 27 (B) is reflected by the reflective electrode 45, there is a blue display.

In FIG. 45D, a state is shown where, after the execution of the preset operation described above, the red particles and the blue particles are arranged in a layered manner on the opposing electrode 37 by the application timing of the voltage to each of the pixel electrodes 35A and 35B being different. Specifically, first, all of the negatively charged particles 26 (R) are moved to the opposing electrode 37 side by applying the negative voltage VL to the pixel electrode 35A, and next, the positively charged particles 27 (B) are moved to the opposing electrode 37 side by applying the positive voltage VH to the pixel electrode 35B and are arranged directly below the negatively charged particles 26 (R). In this manner, the red particles and the blue particles are layered in the vicinity of the opposing electrode 37. As a result, since there is no visible light which is able to pass through both the red particles and the blue particles, there is a black display.

Here, in this example, the red particles are arranged to come into contact with the opposing electrode 37, but the application timing with regard to the pixel electrodes 35A and 35B may be controlled so as to arrange the red particles below the blue particles after the blue particles are moved to come into contact with the opposing electrode 37. That a black display is possible is because the wavelengths of the red particles and the blue particles do not overlap. That is, it is possible to perform a black display by using the two colors of particles where the wavelengths of the complementary colors and the like do not overlap.

In FIG. 46A, the distribution state of the particles is shown when a pale red display is performed.

After the preset operation described above, the negative voltage V1 (V1<|VL|) is applied to the pixel electrode 35A and a portion of the negatively charged particles 26 (R) with a red color move to the opposing substrate 310 side. Even here, the gradation of the display color is controlled using the area of the particles which are visually recognized in practice viewed from the opposing substrate side.

As shown in FIG. 46B, it is possible to perform a black display even in a state where the particles are randomly dispersed in the dispersion medium 21 (T).

Here, by the size of the applied voltage or the application time to each of the pixel electrodes 35A and 35B being controlled, a portion of the negatively charged particles 26 (R) with a red color and the positively charged particles 27 (B) with a blue color are moved to the opposing electrode 37 side and are suspended in the dispersion medium 21 (T), and each of the particles are randomly dispersed. Even in the distribution state of the particles such as this, since the outside light is absorbed in the respective charged particles 26 (R) and 27 (B), a black display can be obtained.

Here, the potential of the reflective electrode 45 may be floating, or the potential may be applied.

In addition, the description above describes the display device where electrophoresis is used, but in practice, dielectrophoresis may be included therein. In a case where both are mixed, it is difficult for each of these to be strictly separated. Also in this case, in a case where the same phenomena as the description of the embodiment are generated, it is possible to consider it as an example of the embodiment.

In addition, the movement of the particles is assisted by the movement of the dispersion medium 21 which is generated by the movement of the particles 26 and 27 and the like, and it is easier to move the particles, but this case is also the same as described above.

1. An electrophoretic display device comprising:
a first substrate;
a second substrate;
an electrophoretic layer which is arranged between the first substrate and the second substrate and has at least a dispersion medium and particles mixed in the dispersion medium;
a plurality of first electrodes which is formed in an island shape on the electrophoretic layer side of the first substrate and is provided for each pixel; and
a second electrode which is formed on the electrophoretic layer side of the second substrate with an area wider than that of the first pixel electrode,
wherein gradation is controlled using an area of the particles which are visually recognized when the electrophoretic layer is viewed from the second electrode side.

2. The electrophoretic display device according to claim 1,
wherein the plurality of first electrodes is mutually connected by a connection electrode formed in a layer further to the first substrate side than the first electrode.

3. The electrophoretic display device according to claim 2, further comprising:
a scanning line and a data line,
wherein a transistor which is connected to the scanning line and the data line is arranged in the pixel, and
the connection electrode is formed in a different layer to a drain electrode of the transistor.

4. The electrophoretic display device according to claim 3,
wherein the connection electrode overlaps with at least a portion of the transistor in a planar view.

5. The electrophoretic display device according to claim 1,
wherein the total area of the plurality of first electrodes in the pixel is equal to or less than ¼ of the area of the pixel.

6. The electrophoretic display device according to claim 1,
wherein the width of the first electrodes in a direction where the first electrodes are adjacent to each other is shorter than a gap between the first electrode and the second electrode.

7. The electrophoretic display device according to claim 1,
wherein the plurality of first electrodes provided in the pixel includes two or more types of electrodes which have sizes different from each other.

8. An electrophoretic display device comprising:
a first substrate;
a second substrate;
an electrophoretic layer which is arranged between the first substrate and the second substrate and has at least a dispersion medium and particles mixed in the dispersion medium;
a plurality of first electrodes and a plurality of third electrodes which are formed in an island shape on the electrophoretic layer side of the first substrate and are provided in one pixel; and
a second electrode which is formed on the electrophoretic layer side of the second substrate with an area wider than that of the first electrode and the third electrode;
wherein the first electrodes and the third electrodes are driven independently of each other, and
gradation is controlled using an area of the particles which are visually recognized when the electrophoretic layer is viewed from the second electrode side.

9. The electrophoretic display device according to claim 8,
wherein the plurality of first electrodes is mutually connected by a first connection electrode formed in a layer further to the first substrate side than the first electrode, and
the plurality of third electrodes is mutually connected by a second connection electrode formed in a layer further to the first substrate side than the third electrode.

10. The electrophoretic display device according to claim 9, further comprising:
a first scanning line, a second scanning line, a first data line, and a second data line,
wherein a first transistor which is connected to the first scanning line and the first data line and a second transistor which is connected to the second scanning line and the second data line are arranged in the pixel,
the first connection electrode is formed in a different layer to a drain electrode of the first transistor, and
the second connection electrode is formed in a different layer to a drain electrode of the second transistor.

11. The electrophoretic display device according to claim 10,
wherein the first connection electrode overlaps with at least a portion of the first transistor in a planar view, and
the second connection electrode overlaps with at least a portion of the second transistor in a planar view.

12. The electrophoretic display device according to claim 8,
wherein the total area of the plurality of first electrodes and the plurality of third electrodes in one pixel is equal to or less than ¼ of the area of one pixel.

13. The electrophoretic display device according to claim 8,
wherein the widths of the first electrode and the third electrode in a direction where the first electrode and the third electrode are adjacent to each other are shorter than a gap between the first electrode and the second electrode.

14. The electrophoretic display device according to claim 8,
wherein the plurality of first electrodes provided in the pixel includes two or more types of electrodes which have sizes different from each other, and
the plurality of third electrodes provided in the pixel includes two or more types of electrodes which have sizes different from each other.

15. The electrophoretic display device according to claim 1,
wherein the plurality of first electrodes is arranged at equal intervals.

16. The electrophoretic display device according to claim 1,
wherein the plurality of first electrodes is arranged at random positions.

17. The electrophoretic display device according to claim 1,
wherein the size of the plurality of first electrodes is random.

18. The electrophoretic display device according to claim 1, further comprising:
a first pixel and a second pixel,
wherein the layout of the plurality of first electrodes in the first pixel is different from the layout of the plurality of first electrodes in the second pixel.

19. The electrophoretic display device according to claim 1,
wherein the layout of the first electrode of the pixel includes two regions which are different from each other.

20. An electronic apparatus comprising:
the electrophoretic display device according to claim 1.
